(19) United States
(12) Patent Application Publication
(10) Pub. No.: US 2016/0162076 A1
(43) Pub. Date: Jun. 9, 2016

(54) ADHESIVE SHEET FOR TOUCH PANELS, LAMINATE FOR TOUCH PANELS AND CAPACITIVE TOUCH PANEL

(71) Applicant: FUJIFILM Corporation, Tokyo (JP)

(72) Inventors: Kiyotaka FUKAGAWA, Kanagawa (JP); Satoshi TANAKA, Kanagawa (JP)

(73) Assignee: FUJIFILM Corporation, Tokyo (JP)

(21) Appl. No.: 15/041,162

(22) Filed: Feb. 11, 2016

Related U.S. Application Data
(63) Continuation of application No. PCT/JP2014/071493, filed on Aug. 15, 2014.

(30) Foreign Application Priority Data
Aug. 21, 2013 (JP) 2013-171225
Feb. 18, 2014 (JP) 2014-028089
Jul. 7, 2014 (JP) 2014-139661

(51) Int. Cl. G06F 3/044; C09J 7/00

(52) U.S. Cl. CPC G06F 3/044; C09J 7/00; G06F 2203/04103; C09J 133/08

(57) ABSTRACT

An adhesive sheet for touch panels at least includes: a (meth)acrylic adhesive; and a hydrophobic additive, in which a ratio of the number of moles of oxygen atoms with respect to the number of moles of carbon atoms in the (meth)acrylic adhesive is 0.08 to 0.20, a ratio of the number of moles of oxygen atoms with respect to the number of moles of carbon atoms in the hydrophobic additive is 0 to 0.10, the content of the hydrophobic additive is 20 mass % to 80 mass % with respect to the total mass of the adhesive sheet, a ratio of the number of moles of oxygen atoms with respect to the number of moles of carbon atoms contained in the adhesive sheet is 0.03 to 0.15, and a maximum value of loss tangent is shown within a range of −5° C. to 60° C.

### CROSS-REFERENCE TO RELATED APPLICATIONS

This application is a Continuation of PCT International Application No. PCT/JP2014/071493 filed on Aug. 15, 2014, which claims priority under 35 U.S.C. §119(a) to Japanese Patent Application No. 2013-171225 filed on Aug. 21, 2013, Japanese Patent Application No. 2014-028089 filed on Feb. 18, 2014 and Japanese Patent Application No. 2014-139661 filed on Jul. 7, 2014. Each of the above applications is hereby expressly incorporated by reference, in its entirety, into the present application.

### BACKGROUND OF THE INVENTION

1. Field of the Invention

The present invention relates to an adhesive sheet for touch panels, and particularly, to an adhesive sheet for touch panels containing a component showing a predetermined ratio of the number of moles of oxygen atoms and the number of moles of carbon atoms.

In addition, the invention relates to a laminate for touch panels and a capacitive touch panel, each of which includes the adhesive sheet for touch panels.

2. Description of the Related Art

In recent years, the rate of installation of touch panels in cell phones, portable game equipment, or the like has increased, and for example, capacitive touch panels enabling multipoint detection (hereinafter, also simply referred to as touch panel) have attracted attention.

In general, in the manufacturing of touch panels, a transmission visible adhesive sheet is used for adhesion between members such as a display device and a touch panel sensor, and various adhesive sheets are suggested.

For example, JP2009-155503A discloses a double-sided pressure-sensitive adhesive tape which is capable of suppressing the generation of bubbles at a stepped part in bonding between a transparent panel having a step generated due to a decorative part and a flat surface of an image display device, and the generation of bubbles over time, and which has excellent drop impact resistance. The double-sided pressure-sensitive adhesive tape is characterized in that it has a maximum value of loss tangent in a temperature region of −40° C. to −10° C.

### SUMMARY OF THE INVENTION

Adhesive sheets used in touch panels are required to have various characteristics. For example, in view of adaptability of touch panels to the environment, touch panels including an adhesive sheet are required not to malfunction under various use environments such as a cold region and a warm region. In view of durability of touch panels, adhesive sheets are also required to have excellent adhesiveness. In view of visibility of touch panels, adhesive sheets are also required to have excellent transparency.

As described above, adhesive sheets used in touch panels are required to have adhesiveness and transparency, and to hardly cause malfunction of the touch panels including the adhesive sheet.

The inventors could not obtain an adhesive sheet satisfying all of the three requirements when producing a touch panel using the double-sided pressure-sensitive adhesive tape described in JP2009-155503A.

In view of the circumstances, an object of the invention is to provide an adhesive sheet for touch panels which is capable of suppressing the occurrence of malfunction of a capacitive touch panel and has excellent adhesiveness and transparency under a wide temperature range of low to high temperatures.

In addition, an object of the invention is to provide a laminate for touch panels and a capacitive touch panel, each of which includes the adhesive sheet for touch panels.

The inventors have conducted intensive studies on the above-described task, and as a result, found that an adhesive sheet containing a component showing a predetermined ratio of the number of moles of oxygen atoms and the number of moles of carbon atoms provides a predetermined effect.

That is, the inventors have found that the above-described objects can be achieved with the following configurations.

(1) An adhesive sheet for touch panels including at least: a (meth)acrylic adhesive; and a hydrophobic additive, in which a ratio of the number of moles of oxygen atoms and the number of moles of carbon atoms (number of moles of oxygen atoms/number of moles of carbon atoms) in the (meth)acrylic adhesive is 0.08 to 0.20, a ratio of the number of moles of oxygen atoms and the number of moles of carbon atoms (number of moles of oxygen atoms/number of moles of carbon atoms) in the hydrophobic additive is 0 to 0.10, the content of the hydrophobic additive is 20 mass % to 80 mass % with respect to the total mass of the adhesive sheet for touch panels, a ratio of the number of moles of oxygen atoms and the number of moles of carbon atoms (number of moles of oxygen atoms/number of moles of carbon atoms) contained in the adhesive sheet for touch panels is 0.03 to 0.15, and a maximum value of loss tangent (tans) is shown within a range of −5° C. to 60° C.

(2) The adhesive sheet for touch panels according to (1), in which the temperature dependency of a specific dielectric constant obtained from a temperature dependency evaluation test to be described later is 20% or less.

(3) The adhesive sheet for touch panels according to (1) or (2), in which the content of the hydrophobic additive is 40 mass % to 60 mass % with respect to the total mass of the adhesive sheet for touch panels.

(4) The adhesive sheet for touch panels according to any one of (1) to (3), in which the hydrophobic additive includes at least one selected from the group consisting of a terpene-based resin, a rosin-based resin, a coumarone indene-based resin, a rubber-based resin, and a styrene-based resin.

(5) The adhesive sheet for touch panels according to any one of (1) to (4), in which the hydrophobic additive includes at least one selected from the group consisting of a hydrogenated terpene phenol resin and an aromatic modified terpene resin.

(6) A laminate for touch panels including: the adhesive sheet for touch panels according to any one of (1) to (5); and a capacitive touch panel sensor.

(7) The laminate for touch panels according to (6), further including: a protective substrate, in which the capacitive touch panel sensor, the adhesive sheet for touch panels, and the protective substrate are provided in this order.

(8) A capacitive touch panel including, in this order, at least: a display device; the adhesive sheet for touch panels according to any one of (1) to (5); and a capacitive touch panel sensor.

(9) The capacitive touch panel according to (8), in which the size in a diagonal direction of an input region capable of detecting the contact of an object in the capacitive touch panel sensor is 5 inches or greater.

According to the invention, it is possible to provide an adhesive sheet for touch panels which is capable of suppressing the occurrence of malfunction of a capacitive touch panel and has excellent adhesiveness and transparency under a wide temperature range of low to high temperatures.

In addition, according to the invention, it is also possible to provide a laminate for touch panels and a capacitive touch panel, each of which includes the adhesive sheet for touch panels.

### BRIEF DESCRIPTION OF THE DRAWINGS

FIG. 1 is a schematic diagram of a sample for evaluation which is used in a temperature dependency evaluation test.

FIG. 2 shows an example of results of a temperature dependency evaluation test.

FIG. 3 is a cross-sectional view of a first embodiment of a laminate for touch panels of the invention.

FIG. 4 is a cross-sectional view of a second embodiment of the laminate for touch panels of the invention.

FIGS. 5A and 5B are cross-sectional views of a capacitive touch panel of the invention.

FIG. 6 is a plan view of an embodiment of a capacitive touch panel sensor.

FIG. 7 is a cross-sectional view taken along cutting line A-A shown in FIG. 6.

FIG. 8 is an enlarged plan view of a first detection electrode.

FIG. 9 shows a partial cross-section of another embodiment of the capacitive touch panel sensor.

FIG. 10 shows a partial cross-section of still another embodiment of the capacitive touch panel sensor.

FIG. 11 shows a partial cross-section of an embodiment of still another embodiment of the capacitive touch panel sensor.

FIG. 12 is a cross-sectional view taken along cutting line A-A shown in FIG. 11.

### DESCRIPTION OF THE PREFERRED EMBODIMENTS

Hereinafter, preferred aspects of an adhesive sheet for touch panels (hereinafter, also referred to as “adhesive sheet”) of the invention will be described with reference to the drawings.

In this description, a (meth)acrylic adhesive means an acrylic adhesive and/or a methacrylic adhesive. A (meth)acrylic polymer means an acrylic polymer and/or a methacrylic polymer. A (meth)acrylate monomer means an acrylate monomer and/or a methacrylate monomer.

In this description, the numerical value range expressed using “to” means a range including the numerical values described before and after “to” as a lower limit value and an upper limit value.

The adhesive sheet (optical adhesive sheet) of the invention is characterized in that it contains a component showing a predetermined ratio of the number of moles of oxygen atoms and the number of moles of carbon atoms, and has a maximum value of loss tangent (tans) within a predetermined temperature range.

The inventors have found that the specific dielectric constant of the adhesive sheet greatly changes according to the amount (number of moles) of oxygen atoms and carbon atoms in constituent components of the sheet and according to the use environment. The reason for this is presumed to be the adsorption of moisture due to the oxygen atoms and electronic influences. When such an adhesive sheet in which the change in the specific dielectric constant is large is used in a touch panel, for example, when a touch panel is operated using a human finger under a low-temperature environment at a temperature that is lower than human body temperature by 10° C. or higher, a change in the capacitance due to the actual operation and a change in the capacitance due to the temperature change caused by the contact in the adhesive sheet simultaneously occur. In the case of the change in the capacitance due to the temperature change, a time to reach the equilibrium is long, and thus the contact position is falsely recognized and this lead to an operation error. Accordingly, the inventors have found that the occurrence of malfunction can be suppressed by adjusting the amount of oxygen atoms and carbon atoms of various constituent components of the adhesive sheet.

The adjustment of the amount of oxygen atoms and carbon atoms of the components also has an influence on the compatibility of the various components, and by using components within the ranges specified in the invention, an adhesive sheet which is also excellent in transparency is obtained.

With an improvement in the compatibility, adhesiveness of the adhesive sheet is also further improved by adjusting the range of the loss tangent (tans) of the adhesive sheet.

Hereinafter, aspects of the adhesive sheet of the invention will be described in detail.

<Adhesive Sheet for Touch Panels (Adhesive Sheet)>

The adhesive sheet is a sheet for securing adhesiveness between members.

Particularly, the adhesive sheet of the invention is preferably for use in touch panels as will be described later.

The adhesive sheet is an adhesive sheet containing at least a predetermined (meth)acrylic adhesive and a predetermined hydrophobic additive.

First, various components contained in the adhesive sheet will be described in detail as follows.

((Meth)Acrylic Adhesive)

The (meth)acrylic adhesive is an adhesive containing a (meth)acrylic polymer as a base polymer. The (meth)acrylic adhesive may have or may not have a crosslinked structure, but preferably includes a crosslinked structure (three-dimensional crosslinked structure) in view of an improvement in adhesiveness. The (meth)acrylic adhesive including a crosslinked structure can also be synthesized by reacting a (meth)acrylic polymer having a reactive group (for example, hydroxyl group, carboxyl group, or the like) reacting with a crosslinking agent with a predetermined crosslinking agent as will be described later.

The ratio of the number of moles of oxygen atoms with respect to the number of moles of carbon atoms, that is, the ratio of the number of moles of oxygen atoms and the number of moles of carbon atoms (number of moles of oxygen atoms/number of moles of carbon atoms) (hereinafter, also referred to as “O/C ratio”) in the (meth)acrylic adhesive is 0.08 to 0.20, and in view of transparency and adhesiveness of the adhesive sheet and in view of more excellent effects in at least one of the malfunction of the touch panel and the suppression (hereinafter, also simply referred to as “in view of more excellent effects of the invention”), the O/C ratio is preferably 0.09 to 0.19, and more preferably 0.10 to 0.19.

When the O/C ratio is less than 0.08, the synthesis of the (meth)acrylic adhesive is difficult, and when the O/C ratio is greater than 0.20, the malfunction of the touch panel easily occurs, or the transparency of the adhesive sheet deteriorates.

Regarding the O/C ratio, the number of moles (molar quantity) of oxygen atoms and the number of moles (molar quantity) of carbon atoms contained in the (meth)acrylic adhesive are calculated, and the ratio thereof is obtained.

For example, when the (meth)acrylic adhesive includes a polymer composed of only a repeating unit including ten carbon atoms and two oxygen atoms, the O/C ratio is calculated to be 2/10=0.2.

When the (meth)acrylic adhesive includes two or more types of repeating units, the O/C ratio is obtained using the molar quantities of the respective repeating units contained. A specific example thereof will be described as follows.

Here, a method of calculating an O/C ratio when the (meth)acrylic adhesive includes a repeating unit X derived from a monomer X including fourteen carbon atoms and two oxygen atoms and a repeating unit Y derived from a monomer Y including six carbon atoms and two oxygen atoms will be described in detail. Here, the molar quantities of the repeating unit X and the repeating unit Y contained are 0.8 moles and 0.2 moles, respectively. Here, when the monomer X and the monomer Y become the repeating unit X and the repeating unit Y, respectively, there are no changes in the number of carbon atoms and the number of oxygen atoms, and the molar quantities of the repeating units are synonymous with the molar quantities of the monomer X and the monomer Y.

First, regarding the number of moles of carbon atoms, the number of moles of carbon atoms derived from the repeating unit X and the number of moles of carbon atoms derived from the repeating unit Y are calculated to obtain a total value. Specifically, the number of moles of carbon atoms is calculated to be [0.8 (molar quantity of repeating unit X)×14 (number of carbon atoms in repeating unit X)]+[0.2 (molar quantity of repeating unit Y)×6 (number of carbon atoms in repeating unit Y)]=12.4.

The number of moles of oxygen atoms is calculated to be [0.8 (molar quantity of repeating unit X)×2 (number of oxygen atoms in repeating unit X)]+[0.2 (molar quantity of repeating unit Y)×2 (number of oxygen atoms in repeating unit Y)]=2.0.

Accordingly, the O/C ratio is calculated to be 2.0/12.4=0.16.

When the (meth)acrylic adhesive is a reactant of the (meth)acrylic polymer and the crosslinking agent, the O/C ratio can be calculated with reference to a ratio of the amount of the (meth)acrylic polymer used and the amount of the crosslinking agent used.

For example, a case in which the (meth)acrylic polymer is a polymer composed of a repeating unit Z derived from a monomer Z including ten carbon atoms and two oxygen atoms and the crosslinking agent includes six carbon atoms and two oxygen atoms will be examined. The molar quantity of the repeating unit Z (molar quantity of monomer Z) is 1 mole and the amount of the crosslinking agent used is 0.1 moles.

The number of moles of carbon atoms in the (meth)acrylic adhesive is calculated to be [1 (molar quantity of repeating unit Z)×10 (number of carbon atoms in repeating unit Z)]+[0.1 (molar quantity of crosslinking agent)×6 (number of carbon atoms in crosslinking agent)]=10.6.

The number of moles of oxygen atoms in the (meth)acrylic adhesive is calculated to be [1 (molar quantity of repeating unit Z)×2 (number of oxygen atoms in repeating unit Z)]+[0.1 (molar quantity of crosslinking agent)×2 (number of oxygen atoms in crosslinking agent)]=2.2.

Accordingly, the O/C ratio is calculated to be 2.2/10.6=0.20.

The (meth)acrylic adhesive may contain other atoms (for example, hydrogen atoms and hetero atoms such as nitrogen atoms) other than the oxygen atoms and the carbon atoms.

The (meth)acrylic adhesive is preferably formed to mainly have oxygen atoms and carbon atoms as main components. Here, the main components mean that the total value of the total mass of oxygen atoms and the total mass of carbon atoms (total mass of oxygen atoms+total mass of carbon atoms) with respect to the total mass in the (meth)acrylic adhesive is 70 mass % or greater, and in view of more excellent effects of the invention, the total value is preferably 80 mass % or greater, and more preferably 90 mass % or greater. The upper limit is not particularly limited, but 100 mass % is exemplified.

The number of moles of oxygen atoms and carbon atoms in the (meth)acrylic adhesive can be calculated from the charge amount of the monomers used or through a known method (for example, ¹H NMR).

As an example of the known method, a method in which the side-chain ester of an acrylic polymer is hydrolyzed by a base such as NaOH and an alcohol component extracted is identified using ¹H NMR or liquid chromatography is exemplified. In addition, when a hydrophobic additive is added, the calculation can be performed in such a manner that the extraction is performed using an organic solvent and analysis is performed using ¹H NMR or the like.

The repeating unit of the (meth)acrylic adhesive is not particularly limited as long as the (meth)acrylic adhesive satisfies the ratio (number of moles of oxygen atoms/number of moles of carbon atoms). However, in view of easy synthesis and easy control of the ratio, the (meth)acrylic adhesive preferably has a repeating unit (hereinafter, also referred to as repeating unit X) derived from a (meth)acrylate monomer having 9 to 21 carbon atoms.

Examples of the(meth)acrylate monomer having the above-described number of carbon atoms include hexyl(meth)acrylate, 2-ethylhexyl(meth)acrylate, n-octyl(meth)acrylate, isooctyl(meth)acrylate, n-nonyl(meth)acrylate, isononyl(meth)acrylate, n-decyl(meth)acrylate, isodecyl(meth)acrylate, n-undecyl(meth)acrylate, n-dodecyl(meth)acrylate, n-tridecyl(meth)acrylate, n-tetradecyl(meth)acrylate, n-pentadecyl(meth)acrylate, n-hexadecyl(meth)acrylate, n-heptadecyl(meth)acrylate, stearyl(meth)acrylate, isoundecyl(meth)acrylate, isododecyl(meth)acrylate, isotridecyl(meth)acrylate, isotetradecyl(meth)acrylate, isopentadecyl(meth)acrylate, isohexadecyl(meth)acrylate, isoheptadecyl(meth)acrylate, isostearyl(meth)acrylate, benzyl(meth)acrylate, isobornyl(meth)acrylate, dicyclopentenyl(meth)acrylate, dicyclopentanyl(meth)acrylate, and dicyclopentenyloxyethyl(meth)acrylate.

In the (meth)acrylic adhesive, the content of the repeating unit X is preferably 90 mole % or greater, and more preferably 95 mole % or greater with respect to the total repeating units of the (meth)acrylic adhesive in view of more excellent effects of the invention. The upper limit is not particularly limited, but 100 mole % is exemplified.

The (meth)acrylic adhesive may contain a monomer other than the above-described monomers as a repeating unit within a range not to impair the effects of the invention. For example, for an improvement in the adhesiveness by a polar component, methoxyethyl(meth)acrylate, 3-methoxybutyl(meth)acrylate, methoxydipropylene glycol(meth)acrylate, methoxytripropylene glycol(meth)acrylate, methoxypolyethylene glycol(meth)acrylate, polyethylene glycol(meth)acrylate, polypropylene glycol(meth)acrylate, poly(ethylene glycol-tetramethylene glycol)acrylate, poly(propylene glycol-tetramethylene glycol)acrylate, polyethylene glycol-polypropylene glycol acrylate, glycidyl(meth)acrylate, N-vinylpyrrolidone, N-vinyl formamide, vinylcaprolactone, 1-vinylimidazole, and the like may be contained.

The (meth)acrylic adhesives may be used alone or in combination of two or more types thereof.

The (meth)acrylic adhesive is an adhesive containing a (meth)acrylic polymer as a base polymer.

As described above, the (meth)acrylic adhesive is formed by reacting the (meth)acrylic polymer reacting with a crosslinking agent with the crosslinking agent, and may have a crosslinked structure.

The (meth)acrylic polymer reacting with a crosslinking agent preferably has a repeating unit derived from a (meth)acrylate monomer having a reactive group (group reacting with crosslinking agent) such as a hydroxyl group and a carboxyl group.

Examples of the (meth)acrylate monomer having a hydroxyl group include 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, and 12-hydroxylauryl(meth)acrylate.

When the (meth)acrylic polymer contains a repeating unit (hereinafter, also referred to as repeating unit Y) derived from the (meth)acrylate monomer having a hydroxyl group, the content of the repeating unit Y is preferably 0.1 mole % to 10 mole %, and more preferably 0.5 mole % to 5 mole % with respect to the total repeating units of the (meth)acrylic polymer in view of more excellent effects of the invention.

The method of polymerizing the (meth)acrylic adhesive used in the invention is not particularly limited, and polymerization can be performed by a known method such as solution polymerization, emulsion polymerization, bulk polymerization, suspension polymerization, or alternating copolymerization. The obtained copolymer may be any one of a random copolymer, a block copolymer, and the like.

The content of the (meth)acrylic adhesive in the adhesive sheet is not particularly limited, but is preferably 25 parts by mass to 400 parts by mass, and more preferably 66 parts by mass to 150 parts by mass with respect to 100 parts by mass of a hydrophobic additive to be described later in view of more excellent effects of the invention.

(Hydrophobic Additive)

The hydrophobic additive is a compound for making the adhesive sheet more hydrophobic.

The ratio of the number of moles of oxygen atoms with respect to the number of moles of carbon atoms, that is, the ratio of the number of moles of oxygen atoms and the number of moles of carbon atoms (number of moles of oxygen atoms/number of moles of carbon atoms) in the hydrophobic additive is 0 to 0.10, and in view of more excellent effects of the invention, the ratio is preferably 0 to 0.05, and more preferably 0 to 0.01. When the ratio is 0, this case means that the number of moles of oxygen atoms is 0.

When the O/C ratio is greater than 0.10, it is difficult to reduce the temperature dependency of the specific dielectric constant of the adhesive sheet, and as a result, malfunction of the touch panel easily occurs, or the transparency of the adhesive sheet deteriorates.

The method of calculating the O/C ratio of the hydrophobic additive is the same as the method of calculating the O/C ratio of the (meth)acrylic adhesive.

The hydrophobic additive may contain other atoms (for example, hydrogen atoms and hetero atoms such as nitrogen atoms) other than the oxygen atoms and the carbon atoms.

The hydrophobic additive is preferably formed to mainly have oxygen atoms and carbon atoms as main components. Here, the main components mean that the total value of the total mass of oxygen atoms and the total mass of carbon atoms (total mass of oxygen atoms+total mass of carbon atoms) with respect to the total mass in the hydrophobic additive is 70 mass % or greater, and in view of more excellent effects of the invention, the total value is preferably 80 mass % or greater, and more preferably 90 mass % or greater. The upper limit is not particularly limited, but 100 mass % is exemplified.

The number of moles of oxygen atoms and carbon atoms in the hydrophobic additive can be calculated from the charge amount of the monomers used or through a known method (for example, ¹H NMR).

The hydrophobic additive is not particularly limited as long as it satisfies the O/C ratio. Examples thereof include a fluorine atom-containing resin and a silicon atom-containing resin other than known tackifiers.

Examples of preferred aspects of the hydrophobic additive include tackifiers such as petroleum-based resins (for example, aromatic petroleum resin, aliphatic petroleum resin, resin obtained by C9 fraction, and the like), terpene-based resins (for example, α-pinene resin, β-pinene resin, terpene phenol copolymer, hydrogenated terpene phenol resin, aromatic modified terpene resin, and abietic ester resin), rosin-based resins (for example, partially hydrogenated gum rosin resin, erythritol modified wood rosin resin, tall oil rosin resin, and wood rosin resin), coumarone indene-based resins (for example, coumarone indene-styrene copolymer), and styrene-based resins (for example, polystyrene, copolymer of styrene and α-methylstyrene, and the like), and rubber-based resins (for example, polybutadiene, polyisoprene, polyisobutylene, polybutene, styrene-butadiene copolymer, modified polybutadiene, modified polyisoprene, modified polyisobutylene, modified polybutene, modified styrene-butadiene copolymer, and the like) in view of more excellent effects of the invention.

Among the tackifiers, a hydrogenated terpene phenol resin and an aromatic modified terpene resin are preferred in view of more excellent effects of the invention.

Among the rubber-based resins, polybutadiene, polyisobutylene, modified polyisoprene, and a styrene-butadiene copolymer are preferred in view of more excellent effects of the invention.

The tackifiers and the rubber-based resins can be used alone or in combination of two or more types thereof, and when two or more types are used in combination, for example, different types of resins may be combined, or resins of the same type having different softening points may be combined.

The content of the hydrophobic additive in the adhesive sheet is 20 mass % to 80 mass % with respect to the total mass of the adhesive sheet. The content is preferably 40 mass % to 60 mass % in view of more excellent effects of the invention.

When the content is less than 20 mass %, it is difficult to reduce the temperature dependency of the specific dielectric constant of the adhesive sheet, and as a result, malfunction of the touch panel easily occurs. When the content is greater than 80 mass %, the adhesiveness deteriorates.

The total content of the (meth)acrylic adhesive and the hydrophobic additive in the adhesive sheet is not particularly limited as long as the content of the hydrophobic additive satisfies the above range, but in view of more excellent effects of the invention, the total content is preferably 85 mass % or greater, more preferably 90 mass % or greater, and even more preferably 95 mass % or greater with respect to the total mass of the adhesive sheet. The upper limit is not particularly limited, but 100 mass % is exemplified.

(Arbitrary Component)

The adhesive sheet may contain components other than the above-described (meth)acrylic adhesive and hydrophobic additive.

For example, a plasticizer is exemplified. As the plasticizer, a phosphoric acid ester-based plasticizer and/or a carboxylic acid ester-based plasticizer are preferred. Preferred examples of the phosphoric acid ester-based plasticizer include triphenyl phosphate, tricresyl phosphate, cresyl diphenyl phosphate, octyl diphenyl phosphate, biphenyl diphenyl phosphate, trioctyl phosphate, and tributyl phosphate. Preferred examples of the carboxylic acid ester-based plasticizer include dimethyl phthalate, diethyl phthalate, dibutyl phthalate, dioctyl phthalate, diphenyl phthalate, diethylhexyl phthalate, triethyl O-acetyl citrate, tributyl O-acetyl citrate, acetyl triethyl citrate, acetyl tributyl citrate, butyl oleate, methyl acetyl ricinoleate, dibutyl sebacate, triacetin, tributyrin, butyl phthalyl butyl glycolate, ethyl phthalyl ethyl glycolate, methyl phthalyl ethyl glycolate, and butyl phthalyl butyl glycolate.

The amount of the plasticizer added is preferably 0.1 mass % to 20 mass %, and more preferably 5.0 mass % to 10.0 mass % with respect to the total mass of the adhesive sheet.

(Characteristics of Adhesive Sheet)

The ratio of the number of moles of oxygen atoms with respect to the number of moles of carbon atoms contained in the adhesive sheet for touch panels of the invention, that is, the ratio of the number of moles of oxygen atoms and the number of moles of carbon atoms (number of moles of oxygen atoms/number of moles of carbon atoms) is 0.03 to 0.15, and in view of more excellent effects of the invention, the ratio is preferably 0.03 to 0.1, and more preferably 0.03 to 0.07.

When the O/C ratio is less than 0.03 or greater than 0.15, it is difficult to reduce the temperature dependency of the specific dielectric constant of the adhesive sheet, and as a result, malfunction of the touch panel easily occurs, or the transparency or adhesiveness of the adhesive sheet deteriorates.

The method of calculating the O/C ratio of the adhesive sheet is the same as the method of calculating the O/C ratio of the (meth)acrylic adhesive, and the O/C ratio can be calculated from amounts of the raw materials of the adhesive sheet used (for example, the (meth)acrylic adhesive and the hydrophobic additive). For example, when the adhesive sheet contains only two types, that is, the (meth)acrylic adhesive and the hydrophobic additive, the O/C ratio of the adhesive sheet is obtained through (number of moles of oxygen atoms of (meth)acrylic adhesive+number of moles of oxygen atoms of hydrophobic additive)/(number of moles of carbon atoms of (meth)acrylic adhesive+number of moles of carbon atoms of hydrophobic additive).

In addition, when the adhesive sheet contains an additive X (arbitrary component) containing carbon atoms and/or oxygen atoms other than the (meth)acrylic adhesive and the hydrophobic additive, the O/C ratio of the adhesive sheet is calculated in consideration of the number of moles of carbon atoms and the number of moles of oxygen atoms of the additive X. Specifically, in this case, the O/C ratio of the adhesive sheet is obtained through (number of moles of oxygen atoms of (meth)acrylic adhesive+number of moles of oxygen atoms of hydrophobic additive+number of moles of oxygen atoms of additive X)/(number of moles of carbon atoms of (meth)acrylic adhesive+number of moles of carbon atoms of hydrophobic additive+number of moles of carbon atoms of additive X).

When two or more types of additives X are contained, the number of moles of oxygen atoms and the number of moles of carbon atoms of each additive are considered. The additive X corresponds to a so-called solid component, and the solvent is not included.

The adhesive sheet shows a maximum value of loss tangent (tans) within a range of −5° C. to 60° C. The maximum value of loss tangent (tans) is preferably shown within a range of 0° C. to 50° C., and more preferably shown within a range of 10° C. to 45° C. in view of more excellent adhesiveness of the adhesive sheet. When the maximum value of loss tangent (tans) is shown at a temperature lower than −5° C. or higher than 60° C., the adhesiveness of the adhesive sheet deteriorates.

The loss tangent (tans) is a value of loss tangent (tans) which is measured in a shear mode at −50° C. to 100° C. at 10 Hz by a dynamic viscoelasticity device. Specifically, an adhesive sheet having an average thickness of 500 μm is punched out into a rectangular shape of 5 mm×22 mm and is held by measurement chucks. While applying shear strain at a frequency of 10 Hz using a viscoelasticity tester (device name “Rheogel-E4000” manufactured by UBM), viscoelasticity is measured in a shear mode at a rate of temperature increase of 5° C./min within a temperature region of −50° C. to 100° C., and a temperature at which the maximum value of loss tangent (tans) is shown is obtained. The average thickness is a value obtained by measuring thicknesses of ten arbitrary places in the adhesive sheet and by arithmetically averaging the measured values.

The thickness of the adhesive sheet is not particularly limited, but is preferably 5 μm to 2,500 μm, and more preferably 20 μm to 500 μm. When the thickness is within the range, a desired visible light transmittance is obtained, and handling is facilitated.

The adhesive sheet is preferably optically transparent. That is, a transparent adhesive sheet is preferred. Optically transparent means that the total light transmittance is 85% or higher. The total light transmittance is preferably 90% or higher, and more preferably 95% or higher.

In view of more hardly causing malfunction of the touch panel including the adhesive sheet, the temperature dependency of the specific dielectric constant of the adhesive sheet, obtained from a temperature dependency evaluation test to be described later, is preferably 20% or less. In view of even more hardly causing malfunction of the touch panel, the temperature dependency is more preferably 15% or less, and particularly preferably 10% or less. The lower limit is not particularly limited, but is preferably as lower as possible. 0% is most preferred.

A method of performing the temperature dependency evaluation test will be described in detail as follows. Usually, the measurement of the specific dielectric constant using an impedance measurement technology at each temperature to be described as follows is called a capacitance method. Conceptually, the capacitance method is a method in which a capacitor is formed by sandwiching a sample between electrodes, and a dielectric constant is calculated from the measured capacitance value. In addition, together with the maturity of ubiquitous society advancing with making electronic equipment with a capacitive touch panel installed therein mobile, the electronic equipment such as a touch panel is inevitably used in the open air, and thus the environmental temperature to which the electronic equipment is exposed is assumed to be −40° C. to 80° C., and in this evaluation test, −40° C. to 80° C. is set as a test environment.

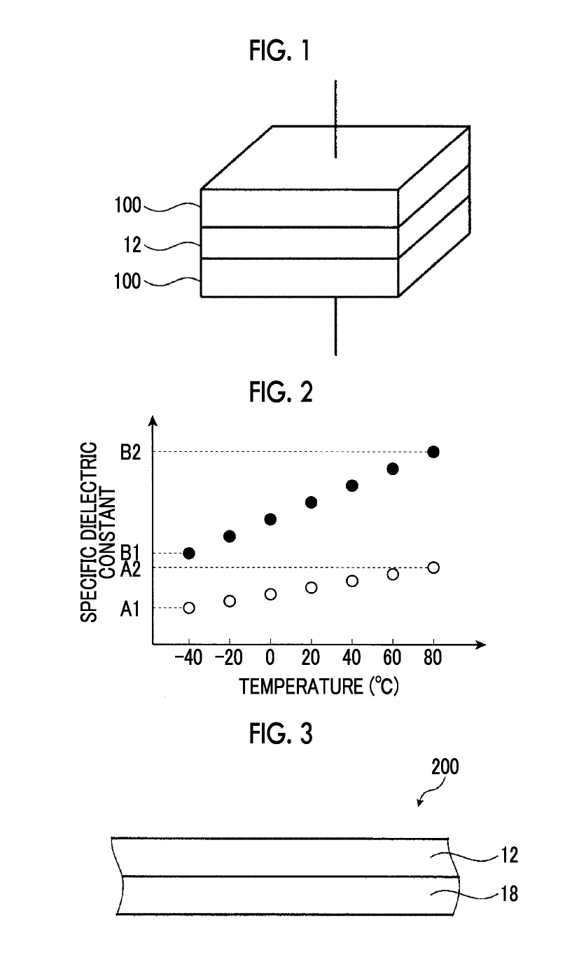

First, as shown in FIG. 1, an adhesive sheet 12 (thickness: 100 μm to 500 μm) as a measurement target is sandwiched between a pair of aluminum electrodes 100 (electrode area: 20 mm×20 mm), and is subjected to a pressurizing/defoaming treatment for 60 minutes at 5 atmospheres at 40° C. to produce a sample for evaluation.

Thereafter, the temperature of the adhesive sheet in the sample is increased from −40° C. to 80° C. by 20° C. in stages to obtain a capacitance C by impedance measurement at 1 MHz using an impedance analyzer (Agilent Technologies, 4294A) at each temperature. Thereafter, the obtained capacitance C is multiplied by a thickness T of the adhesive sheet, and then the obtained value is divided by the product of an area S of the aluminum electrode and a dielectric constant ∈₀ of vacuum (8.854×10⁻¹² F/m) to calculate a specific dielectric constant. That is, the specific dielectric constant is calculated through Expression (X): specific dielectric constant=(capacitance C×thickness T)/(area S×dielectric constant ∈₀ of vacuum).

Specifically, the temperature of the adhesive sheet is increased in stages so as to be −40° C., −20° C., 0° C., 20° C., 40° C., 60° C., and 80° C., and the adhesive sheet is left for 5 minutes at each temperature until the temperature of the adhesive sheet is stabilized. Then, at the temperature, a capacitance C is obtained by impedance measurement at 1 MHz, and a specific dielectric constant at each temperature is calculated from the obtained value.

The thickness of the adhesive sheet is a value obtained by measuring the thickness of the adhesive sheet at each of at least five arbitrary points and by arithmetically averaging the measured values.

Thereafter, the minimum value and the maximum value are selected among the calculated specific dielectric constants, and a ratio of a difference between the maximum value and the minimum value to the minimum value is obtained. Specifically, a value (%) which is calculated through an expression [{(maximum value−minimum value)/minimum value}×100] is obtained, and this value is set as the temperature dependency.

FIG. 2 shows an example of results of the temperature dependency evaluation test. The horizontal axis of FIG. 2 indicates a temperature, and the vertical axis indicates a specific dielectric constant. FIG. 2 is an example of measurement results of two types of adhesive sheets. The results related to one adhesive sheet are indicated by white circles, and the results related to the other adhesive sheet are indicated by black circles.

Referring to FIG. 2, in the case of an adhesive sheet A indicated by white circles, specific dielectric constants at the respective temperatures are relatively close to each other, and the change thereof is small. That is, the change in the specific dielectric constant of the adhesive sheet A according to the temperature is small, and the specific dielectric constant of the adhesive sheet A hardly changes in a cold region and in a warm region. As a result, in a touch panel including the adhesive sheet A, the capacitance between detection electrodes hardly deviates from an initially set value, and malfunction hardly occurs. A1 which is the minimum value and A2 which is the maximum value among the white circles in FIG. 2 are selected, and through an expression [(A2−A1)/A1×100], the temperature dependency (%) of the adhesive sheet A can be obtained.

In the case of an adhesive sheet B indicated by black circles, the specific dielectric constant greatly increases with an increase in the temperature, and the change thereof is large. That is, the change in the specific dielectric constant of the adhesive sheet B according to the temperature is large, the capacitance between detection electrodes easily deviates from an initially set value, and malfunction easily occurs. B1 which is the minimum value and B2 which is the maximum value among the black circles in FIG. 2 are selected, and through an expression [(B2−B1)/B1×100], the temperature dependency (%) of the adhesive sheet B can be obtained.

That is, the temperature dependency shows a degree of the change of the dielectric constant according to the temperature, and when this value is small, the specific dielectric constant hardly changes at low (−40° C.) to high (80° C.) temperatures. When this value is large, the change of the specific dielectric constant easily occurs at low (−40° C.) to high (80° C.) temperatures.

The degree of the specific dielectric constant of the adhesive sheet at temperatures from −40° C. to 80° C. at an interval of 20° C. is not particularly limited.

In general, when an insulator exists between conductors such as electrodes, a capacitance C of the insulator between the electrodes is obtained through Capacitance C=Dielectric Constant ∈×Area S÷Layer Thickness T, and the dielectric constant ∈ is obtained through Dielectric Constant ∈=Specific dielectric constant ∈ᵣ×Dielectric Constant ∈₀ of Vacuum.

In a capacitive touch panel, the adhesive sheet is disposed between a capacitive touch panel sensor and a protective substrate (cover member), between the capacitive touch panel sensor and a display device, or between a substrate in the capacitive touch panel sensor and a conductive film provided with detection electrodes disposed on the substrate, and the adhesive sheet itself has a parasitic capacitance. An increase in the parasitic capacitance of the adhesive sheet may be a cause of malfunction in the touch sensing. Accordingly, an increase in the parasitic capacitance of the conductive sheet adjacent to a sensing portion (input region) of the capacitive touch panel sensor causes a charging failure in each sensing site of the sensing portion capable of detecting the contact of an object, and thus may be a cause of malfunction.

In addition, with an increase in the area of the capacitive touch panel in recent years, the total number of grid lines (corresponding to detection electrodes to be described later) of an interface sensor portion tends to increase. In order to obtain appropriate sensing sensitivity, the scan rate should be increased in response to the increase, and thus thresholds of the capacitances of the respective grid lines and the respective sensor nodes should be lowered. Accordingly, the influence of the parasitic capacitance of the adhesive sheet adjacent to the sensing portion relatively increases, and an environment where malfunction easily occurs is made. Therefore, in order to reduce the parasitic capacitance of the adhesive sheet adjacent to the sensing portion, means for reducing the dielectric constant E of the adhesive sheet is taken. Accordingly, the maximum value of the specific dielectric constant of the adhesive sheet at temperatures from −40° C. to 80° C. at an interval of 20° C. is preferably 3.8 or less, more preferably 3.6 or less, and even more preferably 3.5 or less.

The procedures of the method of measuring the specific dielectric constant are the same as those of the temperature dependency evaluation test.

(Method of Manufacturing Adhesive Sheet)

The method of manufacturing the above-described adhesive sheet is not particularly limited, and the manufacturing can be performing using a known method. For example, a method in which the above-described (meth)acrylic adhesive composition (hereinafter, also simply referred to as “composition”) containing the (meth)acrylic adhesive and the hydrophobic additive is applied to a predetermined base (for example, peeling sheet), and if necessary, a hardening treatment is performed thereon to form an adhesive sheet is exemplified. After the formation of the adhesive sheet, if necessary, a peeling sheet may be laminated on an exposed surface of the formed adhesive sheet.

A composition containing a (meth)acrylic polymer before crosslinking, a crosslinking agent, and a hydrophobic additive may be used as the (meth)acrylic additive composition.

Hereinafter, a method using the composition will be described in detail.

The composition may contain other components other than the (meth)acrylic adhesive (or (meth)acrylic polymer having reactive group reacting with crosslinking agent to be described later) and the hydrophobic additive.

For example, the composition may contain a crosslinking agent if necessary. As the crosslinking agent, an isocyanate compound, an epoxy compound, a melamine-based resin, an aziridine derivative, a metal chelate compound, or the like is used. Among these, an isocyanate compound and an epoxy compound are particularly preferably used from the viewpoint of mainly obtaining appropriate cohesive power. These compounds may be used alone or as a mixture of two or more types thereof.

The amount of the crosslinking agent used is not particularly limited, but is preferably 0.01 parts by mass to 10 parts by mass, and more preferably 0.1 parts by mass to 1 part by mass with respect to 100 parts by mass of the (meth)acrylic polymer having a reactive group reacting with the crosslinking agent.

If necessary, the composition may contain a solvent. Examples of the solvent to be used include water, organic solvents (for example, alcohols such as methanol, ketones such as acetone, amides such as formamide, sulfoxides such as dimethyl sulfoxide, esters such as ethyl acetate, ethers, and the like), and mixed solvents thereof.

Other than the materials, conventionally known various additives in a powdery, granular, or foil state, such as a surface lubricant, a leveling agent, an antioxidant, a corrosion inhibitor, a light stabilizer, an ultraviolet absorber, a polymerization inhibitor, a silane coupling agent, an inorganic or organic filler, a metal powder, and a pigment can be appropriately added to the composition according to the uses.

The method of forming the adhesive sheet from the composition is not particularly limited, and a known method can be employed. For example, a method in which the composition is applied to a predetermined base (for example, peeling sheet), and if necessary, a hardening treatment is performed thereon to form an adhesive sheet is exemplified. After the formation of the adhesive sheet, a peeling sheet may be laminated on a surface of the adhesive sheet.

Examples of the method of applying the composition include a gravure coater method, a comma coater method, a bar coater method, a knife coater method, a die coater method, and a roll coater method.

Examples of the hardening treatment include a thermal hardening treatment and a light hardening treatment. The light hardening treatment may be composed of a plurality of hardening processes, and a light wavelength to be used may be appropriately selected from a plurality of wavelengths.

The adhesive sheet may be a type (baseless adhesive sheet) having no base, or a type (adhesive sheet with base attached thereto, such as double-sided adhesive sheet with base attached thereto in which both surfaces of the base have an adhesive layer and single-sided adhesive sheet with base attached thereto in which only one surface of the base has an adhesive layer) having a base in which an adhesive layer is disposed on at least one main surface of the base.

The adhesive sheet is for use in capacitive touch panels, and is disposed to bring various members into close contact with each other.

For example, as shown in FIG. 3, an adhesive sheet 12 may be disposed on a capacitive touch panel sensor 18 to form a laminate for touch panels 200.

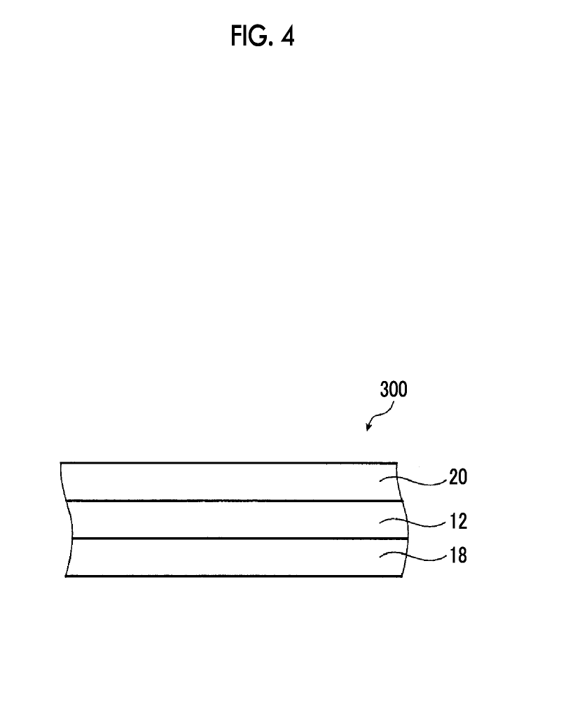

In addition, as shown in FIG. 4, an adhesive sheet 12 may be disposed between a protective substrate 20 and a capacitive touch panel sensor 18 to form a laminate for touch panels 300.

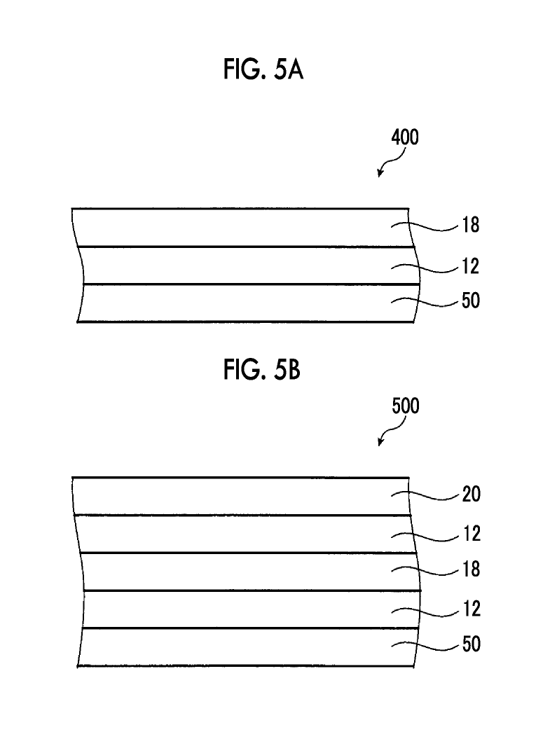

In addition, as shown in FIG. 5A, an adhesive sheet 12 may be disposed between a display device 50 and a capacitive touch panel sensor 18 to form a capacitive touch panel 400.

Moreover, as shown in FIG. 5B, an adhesive sheet 12 may be disposed between a display device 50 and a capacitive touch panel sensor 18 and between the capacitive touch panel sensor 18 and a protective substrate 20 to form a capacitive touch panel 500.

Hereinafter, various members used in the laminate for touch panels and in the capacitive touch panel will be described in detail.

(Capacitive Touch Panel Sensor)

The capacitive touch panel sensor 18 is a sensor which is disposed on a display device (operator side) and detects a position of an external conductor such as a human finger using a change in the capacitance generated when the external conductor such as a human finger is brought into contact with (brought close to) the sensor.

The configuration of the capacitive touch panel sensor 18 is not particularly limited, but in general, the capacitive touch panel sensor has detection electrodes (particularly, detection electrodes extending in X-direction and detection electrodes extending in Y-direction), and detects a change in the capacitance of the detection electrode brought into contact with or brought close to a finger to specify coordinates of the finger.

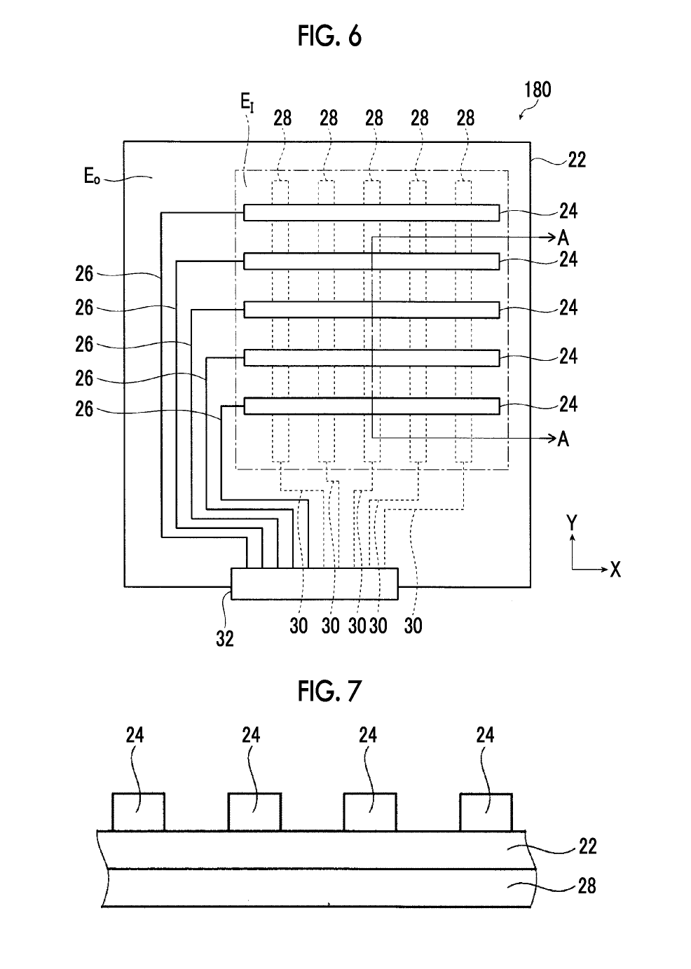

Using FIG. 6, a preferred aspect of the capacitive touch panel sensor 18 will be described in detail.

FIG. 6 shows a plan view of a capacitive touch panel sensor 180. FIG. 7 is a cross-sectional view taken along cutting line A-A of FIG. 6. The capacitive touch panel sensor 180 is provided with a substrate 22, first detection electrodes 24 which are disposed on one main surface (on front surface) of the substrate 22, first lead-out wire portions 26, second detection electrodes 28 which are disposed on the other main surface (on rear surface) of the substrate 22, second lead-out wire portions 30, and a flexible printed wiring board 32. The region where the first detection electrodes 24 and the second detection electrodes 28 are formed constitutes an input region E_{I} (input region (sensing portion) which can detect contact of object) where a user can perform an input operation, and in an outside region E_{O} positioned on the outside of the input region E_{I}, the first lead-out wire portions 26, the second lead-out wire portions 30, and the flexible printed wiring board 32 are disposed.

Hereinafter, the above configuration will be described in detail.

The substrate 22 is a member which acts to support the first detection electrodes 24 and the second detection electrodes 28 in the input region E_{I} and acts to support the first lead-out wire portions 26 and the second lead-out wire portions 30 in the outside region E_{O}.

The substrate 22 preferably appropriately transmits light. Specifically, the total light transmittance of the substrate 22 is preferably 85% to 100%.

The substrate 22 preferably has insulating properties (is insulating substrate). That is, the substrate 22 is a layer for securing insulating properties between the first detection electrodes 24 and the second detection electrodes 28.

The substrate 22 is preferably a transparent substrate (particularly, transparent insulating substrate). Specific examples thereof include an insulating resin substrate, a ceramic substrate, and a glass substrate. Among these, an insulating resin substrate is preferred due to excellent toughness.

Specific examples of the material of the insulating resin substrate include polyethylene terephthalate, polyether sulfone, a polyacrylic resin, a polyurethane-based resin, polyester, polycarbonate, polysulfone, polyamide, polyarylate, polyolefin, a cellulose-based resin, polyvinyl chloride, and a cycloolefin-based resin. Among these, polyethylene terephthalate, a cycloolefin-based resin, polycarbonate, and a triacetyl cellulose resin are preferred due to excellent transparency.

In FIG. 6, the substrate 22 is a single layer, but may be a multi-layer of two or more layers.

The thickness of the substrate 22 (when the substrate 22 is a multi-layer of two or more layers, total thickness of the layers) is not particularly limited, but is preferably 5 μm to 350 μm, and more preferably 30 μm to 150 μm. When the thickness is within the range, a desired visible light transmittance is obtained, and handling is facilitated.

In FIG. 6, the substrate 22 substantially has a rectangular shape when viewed from the top, but the shape is not limited thereto. For examples, the shape may be a circular shape or a polygonal shape.

The first detection electrodes 24 and the second detection electrodes 28 are sensing electrodes which sense a change in the capacitance, and constitute a sensing portion (sensor portion). That is, when a fingertip is brought into contact with the touch panel, the mutual capacitance between the first detection electrode 24 and the second detection electrode 28 changes, and based on this change, the position of the fingertip is calculated by an IC circuit.

The first detection electrodes 24 act to detect an input position of a user's finger brought close to the input region E_{I} in the X-direction, and have a function to generate a capacitance between the finger and the first detection electrode. The first detection electrodes 24 are electrodes which extend in a first direction (X-direction) and are arranged with predetermined intervals therebetween in a second direction (Y-direction) perpendicular to the first direction, and have a predetermined pattern as will be described later.

The second detection electrodes 28 act to detect an input position of a user's finger brought close to the input region E_{I} in the Y-direction, and have a function to generate a capacitance between the finger and the second detection electrode. The second detection electrodes 28 are electrodes which extend in the second direction (Y-direction) and are arranged with predetermined intervals therebetween in the first direction (X-direction), and have a predetermined pattern as will be described later. In FIG. 6, five first detection electrodes 24 and five second detection electrodes 28 are provided. However, the number is not particularly limited, but may be more than one.

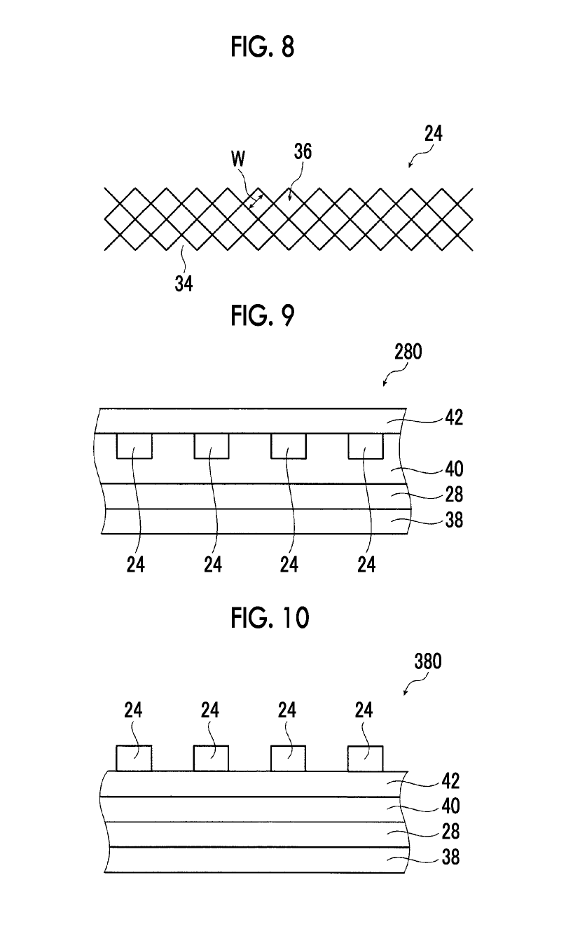

In FIG. 6, the first detection electrodes 24 and the second detection electrodes 28 are composed of fine conductive wires. FIG. 8 shows an enlarged plan view of a part of the first detection electrode 24. As shown in FIG. 8, the first detection electrodes 24 are composed of fine conductive wires 34 and include a plurality of lattices 36 formed by intersecting fine conductive wires 34. Similarly to the first detection electrodes 24, the second detection electrodes 28 also include a plurality of lattices 36 formed by intersecting fine conductive wires 34.

Examples of the material of the fine conductive wire 34 include metals such as gold (Au), silver (Ag), copper (Cr), and aluminum (Al) and alloys thereof, and metal oxides such as ITO, tin oxide, zinc oxide, cadmium oxide, gallium oxide, and titanium oxide. Among these, silver is preferred since the fine conductive wire 34 has excellent conductive properties.

The fine conductive wire 34 preferably contains a binder from the viewpoint of adhesiveness between the fine conductive wire 34 and the substrate 22.

As the binder, a water-soluble polymer is preferred since more excellent adhesiveness is obtained between the fine conductive wire 34 and the substrate 22. Examples of the type of the binder include polysaccharides such as gelatin, carrageenan, polyvinyl alcohol (PVA), polyvinylpyrrolidone (PVP), and starch, cellulose and derivatives thereof, polyethylene oxide, polysaccharide, polyvinylamine, chitosan, polylysine, polyacrylic acid, polyalginic acid, polyhyaluronic acid, carboxy cellulose, gum arabic, and sodium alginate. Among these, gelatin is preferred since more excellent adhesiveness is obtained between the fine conductive wire 34 and the substrate 22.

As the gelatin, acid-treated gelatin may be used other than lime-treated gelatin, and gelatin hydrolysate, an enzymatic decomposition product of gelatin, and gelatin modified with an amino group or a carboxyl group (phthalated gelatin or acetylated gelatin) can be used.

As the binder, a polymer (hereinafter, also simply referred to as polymer) different from the gelatin may be used with the gelatin.

The type of the polymer to be used is not particularly limited as long as it is different from the gelatin, but examples thereof include at least any one selected from the group consisting of an acrylic resin, a styrene-based resin, a vinyl-based resin, a polyolefin-based resin, a polyester-based resin, a polyurethane-based resin, a polyamide-based resin, a polycarbonate-based resin, a polydiene-based resin, an epoxy-based resin, a silicone-based resin, a cellulose-based polymer, and a chitosan-based polymer, and copolymers formed of monomers constituting these resins.

The volume ratio (volume of metal/volume of binder) of the metal and the binder in the fine conductive wire 34 is preferably 1.0 or higher, and more preferably 1.5 or higher. When the volume ratio of the metal and the binder is 1.0 or higher, the conductive properties of the fine conductive wire 34 can be further increased. The upper limit is not particularly limited, but is preferably 6.0 or lower, more preferably 4.0 or lower, and even more preferably 2.5 or lower from the viewpoint of productivity.

The volume ratio of the metal and the binder can be calculated from the densities of the metal and the binder contained in the fine conductive wire 34. For example, when the metal is silver, the density of the silver is calculated to be 10.5 g/cm³, and when the binder is gelatin, the density of the gelatin is calculated to be 1.34 g/cm³ to obtain the volume ratio.

The wire width of the fine conductive wire 34 is not particularly limited. However, from the viewpoint of relatively easily forming a low-resistance electrode, the wire width is preferably 30 μm or less, more preferably 15 μm or less, even more preferably 10 μm or less, particularly preferably 9 μm or less, and most preferably 7 μm or less, and is preferably 0.5 μm or greater, and more preferably 1.0 μm or greater.

The thickness of the fine conductive wire 34 is not particularly limited. However, from the viewpoint of conductive properties and visibility, the thickness can be selected within a range of 0.00001 mm to 0.2 mm, and is preferably 30 μm or less, more preferably 20 μm or less, even more preferably 0.01 μm to 9 μm, and most preferably 0.05 μm to 5 μm.

The lattices 36 include opening regions surrounded by the fine conductive wires 34. A length W of one side of the lattice 36 is preferably 800 μm or less and more preferably 600 μm or less, and is preferably 400 μm or greater.

In the first detection electrodes 24 and the second detection electrodes 28, the opening ratio is preferably 85% or greater, more preferably 90% or greater, and most preferably 95% or greater in view of the visible light transmittance. The opening ratio corresponds to a ratio of a transmissive portion excluding the fine conductive wires 34 in the first detection electrodes 24 or the second detection electrodes 28 in a predetermined region.

The lattices 36 have an almost diamond shape, but may have a polygonal shape (for example, triangular shape, quadrangular shape, hexagonal shape, or random polygonal shape) other than the diamond shape. In addition, one side may have a curved shape or an arc shape other than a linear shape. In the case of an arc shape, for example, two sides opposed to each other may have an outward convex arc shape, and other two sides opposed to each other may have an inward convex arc shape. In addition, each side may have a wave line shape in which outward convex arcs and inward convex arcs are continued. Needles to say, each side may have the shape of a sine curve.

In FIG. 8, the fine conductive wires 34 are formed in a mesh pattern, but are not limited to this aspect. The wires may be formed in a stripe pattern.

The first lead-out wires 26 and the second lead-out wires 30 are members acting to apply a voltage to the first detection electrodes 24 and the second detection electrodes 28, respectively.

The first lead-out wire 26 is disposed on the substrate 22 in the outside region Eo. One end thereof is electrically connected to the corresponding first detection electrode 24, and the other end is electrically connected to the flexible printed wiring board 32.

The second lead-out wire 30 is disposed on the substrate 22 in the outside region Eo. One end thereof is electrically connected to the corresponding second detection electrode 28, and the other end is electrically connected to the flexible printed wiring board 32.

In FIG. 6, five first lead-out wires 26 and five second lead-out wires 30 are provided. However, the number is not particularly limited, and in general, a plurality of lead-out wires are disposed according to the number of detection electrodes.

Examples of the material of the first lead-out wire 26 and the second lead-out wire 30 include metals such as gold (Au), silver (Ag), and copper (Cr), and metal oxides such as tin oxide, zinc oxide, cadmium oxide, gallium oxide, and titanium oxide. Among these, silver is preferred since excellent conductive properties are obtained. In addition, metal pastes such as a silver paste and a copper paste, and metal or alloy thin films such as aluminum (Al) and molybdenium (Mo) may be used to form the lead-out wires. In the case of a metal paste, a screen printing or ink jet printing method is preferably used, and in the case of a metal or alloy thin film, a patterning method such as a photolithographic method is preferably used.

The first lead-out wire 26 and the second lead-out wire 30 preferably contain a binder in view of more excellent adhesiveness with the substrate 22. The type of the binder is as described above.

The flexible printed wiring board 32 is a plate having a plurality of wires and terminals provided on a substrate, and is connected to the other end of each first lead-out wire 26 and the other end of each second lead-out wire 30 to act to connect the capacitive touch panel sensor 180 and an external device (for example, display device).

(Method of Manufacturing Capacitive Touch Panel Sensor)

The method of manufacturing the capacitive touch panel sensor 180 is not particularly limited, and a known method can be employed. For example, a method in which a photoresist film on metal foil formed on both main surfaces of the substrate 22 is subjected to an exposure and development treatment to form a resist pattern, and the metal foil exposed from the resist pattern is subjected to etching is exemplified. In addition, a method in which a paste containing fine metal particles or metal nano-wires is printed on both main surfaces of the substrate 22, and the paste is subjected to metal plating is exemplified. A forming method including printing using a screen printing plate or a gravure printing plate on the substrate 22, or an ink jet forming method is also exemplified.

Other than the above methods, a method using halogenated silver is also exemplified. Specifically, a method including a process (1) of forming a halogenated silver emulsion layer (hereinafter, also simply referred to as photosensitive layer) containing halogenated silver and a binder on both surfaces of the substrate 22, and a process (2) of subjecting the photosensitive layer to a development treatment after exposure is exemplified.

Hereinafter, the processes will be described.

[Process (1): Photosensitive Layer Forming Process]

The process (1) is a process of forming a photosensitive layer containing halogenated silver and a binder on both surfaces of the substrate 22.

The method of forming a photosensitive layer is not particularly limited. However, from the viewpoint of productivity, a method of forming a photosensitive layer on both surfaces of the substrate 22 by bringing a photosensitive layer forming composition containing halogenated silver and a binder into contact with the substrate 22 is preferred.

Hereinafter, an aspect of the photosensitive layer forming composition used in the method will be described in detail, and then the procedures of the process will be described in detail.

The photosensitive layer forming composition contains halogenated silver and a binder.

The halogen element contained in the halogenated silver may be any one of chlorine, bromine, iodine, and fluorine, or a mixture thereof. As the halogenated silver, for example, halogenated silver mainly containing silver chloride, silver bromide, or silver iodide is preferably used, and halogenated silver mainly containing silver bromide or silver chloride is more preferably used.

The type of the binder to be used is as described above. The binder may be contained in a latex form in the photosensitive layer forming composition.

The volume ratio of the halogenated silver and the binder contained in the photosensitive layer forming composition is not particularly limited, and is appropriately adjusted to be within the above-described range of the preferred volume ratio of the metal and the binder in the fine conductive wire 34.

If necessary, the photosensitive layer forming composition contains a solvent.

Examples of the solvent to be used include water, organic solvents (for example, alcohols such as methanol, ketones such as acetone, amides such as formamide, sulfoxides such as dimethyl sulfoxide, esters such as ethyl acetate, ethers, and the like), ionic liquid, and mixed solvents thereof.

The content of the solvent to be used is not particularly limited, but is preferably within a range of 30 mass % to 90 mass %, and more preferably within a range of 50 mass % to 80 mass % with respect to the total mass of the halogenated silver and the binder.

(Procedures of Process)

The method of bringing the photosensitive layer forming composition into contact with the substrate 22 is not particularly limited, and a known method can be employed. Examples thereof include a method of applying the photosensitive layer forming composition to the substrate 22, and a method of dipping the substrate 22 in the photosensitive layer forming composition.

The content of the binder in the photosensitive layer to be formed is not particularly limited, but is preferably 0.3 g/m² to 5.0 g/m², and more preferably 0.5 g/m² to 2.0 g/m².

The content of the halogenated silver in the photosensitive layer is not particularly limited, but is preferably 1.0 g/m² to 20.0 g/m², and more preferably 5.0 g/m² to 15.0 g/m² in terms of silver in view of more excellent conductive characteristics of the fine conductive wire 34.

If necessary, a protective layer formed of a binder may be further provided on the photosensitive layer. By providing the protective layer, scratches are prevented from being formed and mechanical characteristics are improved.

[Process (2): Exposure and Development Process]

The process (2) is a process of forming the first detection electrodes 24 and the first lead-out wires 26, and forming the second detection electrodes 28 and the second lead-out wires 30 by subjecting the photosensitive layer obtained in the process (1) to pattern exposure, and by then performing a development treatment thereon.

First, hereinafter, the pattern exposure treatment will be described in detail, and then the development treatment will be described in detail.

(Pattern Exposure)

The halogenated silver in the photosensitive layer in an exposure region forms a latent image by subjecting the photosensitive layer to pattern exposure. In the region where the latent image is formed, fine conductive wires are formed by the development treatment to be described later. In an unexposed region where the exposure is not performed, the halogenated silver is dissolved and flows out from the photosensitive layer in a fixing treatment to be described later, and a transparent film is obtained.

The light source used during the exposure is not particularly limited, and examples thereof include light such as visible light rays and ultraviolet rays, and radiation such as X-rays.

The method of performing the pattern exposure is not particularly limited. For example, surface exposure using a photomask, or scanning exposure using laser beams may be performed. The shape of the pattern is not particularly limited, and can be appropriately adjusted according to a fine conductive wire pattern to be formed.

(Development Treatment)

The development treatment method is not particularly limited, and a known method can be employed. For example, a usual development treatment technology which is used in a silver salt photographic film, printing paper, a film for printing plate making, an emulsion mask for photomasks, and the like can be used.

The type of a developer used in the development treatment is not particularly limited, but for example, a PQ developer, a MQ developer, a MAA developer, or the like can be used. In commercially available products, developers such as CN-16, CR-56, CP45X, FD-3, and Papitol available from Fujifilm Corporation and C-41, E-6, RA-4, D-19, and D-72 available from Eastman Kodak Company, or developers contained in kits thereof can be used. A lith developer can also be used.

The development treatment may include a fixing treatment which is performed for stabilization by removing the silver salt of the unexposed portion. For the fixing treatment, a fixing treatment technology which is used in a silver salt photographic film, printing paper, a film for printing plate making, an emulsion mask for photomasks, and the like can be used.

The fixing temperature in the fixing process is preferably about 20° C. to about 50° C., and more preferably 25° C. to 45° C. The fixing time is preferably 5 seconds to 1 minute, and more preferably 7 seconds to 50 seconds.

The mass of the metal silver contained in the exposed portion (fine conductive wires) after the development treatment is preferably 50 mass % or greater, and more preferably 80 mass % or greater with respect to the mass of the silver contained in the exposed portion before the exposure. The mass of the silver contained in the exposed portion is preferably 50 mass % or greater with respect to the mass of the silver contained in the exposed portion before the exposure since high conductive properties can be obtained.

If necessary, the following undercoat layer forming process, antihalation layer forming process, or heating treatment may be performed other than the processes.

(Undercoat Layer Forming Process)

Before the process (1), a process of forming an undercoat layer containing the binder on both surfaces of the substrate 22 is preferably performed since excellent adhesiveness is obtained between the substrate 22 and the halogenated silver emulsion layer.

The binder to be used is as described above. The thickness of the undercoat layer is not particularly limited, but is preferably 0.01 μm to 0.5 μm, and more preferably 0.01 μm to 0.1 μm in view of adhesiveness and further suppression of the rate of change of the mutual capacitance.

(Antihalation Layer Forming Process)

A process of forming an antihalation layer on both surfaces of the substrate 22 is preferably performed before the process (1) from the viewpoint of thinning of the fine conductive wires 34.

(Process (3): Heating Process)

A process (3) is performed if necessary, and is a process of performing a heating treatment after the development treatment. By performing this process, fusion occurs between binders, and thus the hardness of the fine conductive wires 34 further increases. Particularly, when polymer particles are dispersed as a binder in the photosensitive layer forming composition (when polymer particles in latex correspond to a binder), fusion occurs between polymer particles by performing this process, and thus fine conductive wires 34 exhibiting desired hardness are formed.

Regarding conditions of the heating treatment, preferred conditions are appropriately selected according to the binder to be used, but from the viewpoint of the film forming temperature of the polymer particles, 40° C. or higher is preferred, 50° C. or higher is more preferred, and 60° C. or higher is even more preferred. From the viewpoint of suppression of a curl of the substrate, 150° C. or lower is preferred, and 100° C. or lower is more preferred.

The heating time is not particularly limited, but is preferably 1 minute to 5 minutes, and more preferably 1 minute to 3 minutes from the viewpoint of productivity and suppression of a curl of the substrate.

In general, the heating treatment can also be performed as a drying process to be performed after the exposure and development treatment, and this is excellent from the viewpoint of productivity and cost since there is no need to add a new process to form a film of the polymer particles.

By performing the process, a light transmissive portion containing the binder is formed between the fine conductive wires 34. Regarding the transmittance in the light transmissive portion, the transmittance indicated by a minimum value of the transmittance in a wavelength region of 380 nm to 780 nm is preferably 90% or greater, more preferably 95% or greater, even more preferably 97% or greater, particularly preferably 98% or greater, and most preferably 99% or greater.

The light transmissive portion may contain a material other than the binder. Examples of the material include a silver-hardly-soluble agent.

The aspect of the capacitive touch panel sensor is not limited to the aspect of FIG. 6, and the capacitive touch panel sensor may have other aspects.

For example, as shown in FIG. 9, a capacitive touch panel sensor 280 is provided with a first substrate 38, second detection electrodes 28 which are disposed on the first substrate 38, second lead-out wires (not shown), each of which is electrically connected to one end of the second detection electrode 28 and is disposed on the first substrate 38, an adhesive sheet 40, first detection electrodes 24, first lead-out wires (not shown), each of which is electrically connected to one end of the first detection electrode 24, a second substrate 42 to which the first detection electrodes 24 and the first lead-out wires are adjacent, and a flexible printed wiring board (not shown).

As shown in FIG. 9, since the capacitive touch panel sensor 280 has a configuration similar to that of the capacitive touch panel sensor 180, except for the first substrate 38, the second substrate 42, and the adhesive sheet 40, the same constituent elements will be denoted by the same references, and descriptions thereof will be omitted.

The Definition of the first substrate 38 and the second substrate 42 is the same as that of the above-described substrate 22.

The adhesive sheet 40 is a layer for bringing the first detection electrodes 24 and the second detection electrodes 28 into close contact with each other, and is preferably optically transparent (is preferably a transparent adhesive sheet). A known material is used as a material of the adhesive sheet 40, and the adhesive sheet 12 may be used as the adhesive sheet 40.

The number of each of the first detection electrode 24 and the second detection electrode 28 in FIG. 9 is more than one as shown in FIG. 6, and both of them are disposed to be perpendicular to each other as shown in FIG. 6.

The capacitive touch panel sensor 280 shown in FIG. 9 corresponds to a capacitive touch panel sensor which has two substrates with electrodes attached thereto, each substrate with electrodes attached thereto having a substrate, and detection electrodes and lead-out wires disposed on a surface of the substrate, and is obtained by sticking the substrates to each other via an adhesive sheet so that the electrodes face to each other.

An aspect shown in FIG. 10 is exemplified as another aspect of the capacitive touch panel sensor.

A capacitive touch panel sensor 380 is provided with a first substrate 38, second detection electrodes 28 which are disposed on the first substrate 38, second lead-out wires (not shown), each of which is electrically connected to one end of the second detection electrode 28 and is disposed on the first substrate 38, an adhesive sheet 40, a second substrate 42, first detection electrodes 24 which are disposed on the second substrate 42, first lead-out wires (not shown), each of which is electrically connected to one end of the first detection electrode 24 and is disposed on the second substrate 42, and a flexible printed wiring board (not shown).

Since the capacitive touch panel sensor 380 shown in FIG. 10 has layers similar to those of the capacitive touch panel sensor 280 shown in FIG. 9, except that the order of the layers is different, the same constituent elements will be denoted by the same references, and descriptions thereof will be omitted.

The number of each of the first detection electrode 24 and the second detection electrode 28 in FIG. 10 is more than one as shown in FIG. 6, and both of them are disposed to be perpendicular to each other as shown in FIG. 6.

The capacitive touch panel sensor 380 shown in FIG. 10 corresponds to a capacitive touch panel sensor which has two substrates with electrodes attached thereto, each substrate with electrodes attached thereto having a substrate, and detection electrodes and lead-out wires disposed on a surface of the substrate, and is obtained by sticking the substrates to each other via an adhesive sheet so that the substrate of one substrate with electrodes attached thereto and the electrodes of the other substrate with electrodes attached thereto face to each other.

As still another aspect of the capacitive touch panel sensor, for example, in FIG. 6, the fine conductive wires 34 of the first detection electrodes 24 and the second detection electrodes 28 may be formed of metal oxide particles or a metal paste such as a silver paste or a copper paste. Among these, a conductive film made of fine silver wires and a silver nano-wire conductive film are preferred in view of excellent conductive properties and transparency.

The first detection electrodes 24 and the second detection electrodes 28 are configured to have a mesh structure of the fine conductive wires 34, but are not limited to this aspect. For example, these may be formed of a metal oxide thin film (transparent metal oxide thin film) such as ITO or ZnO, or a transparent conductive film in which a network is configured with metal nano-wires such as silver nano-wires or copper nano-wires.

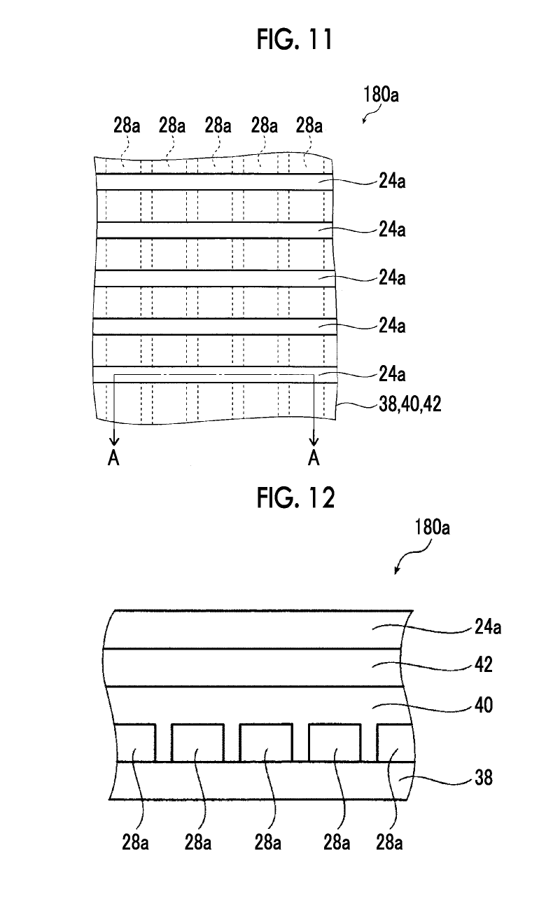

Specifically, as shown in FIG. 11, a capacitive touch panel sensor 180a having first detection electrodes 24a and second detection electrodes 28a composed of a transparent metal oxide may be provided. FIG. 11 shows a partial plan view of an input region of the capacitive touch panel sensor 180a. FIG. 12 is a cross-sectional view taken along cutting line A-A of FIG. 11. The capacitive touch panel sensor 180a is provided with a first substrate 38, second detection electrodes 28a which are disposed on the first substrate 38, second lead-out wires (not shown), each of which is electrically connected to one end of the second detection electrode 28a and is disposed on the first substrate 38, an adhesive sheet 40, a second substrate 42, first detection electrodes 24a which are disposed on the second substrate 42, first lead-out wires (not shown), each of which is electrically connected to one end of the first detection electrode 24a and is disposed on the second substrate 42, and a flexible printed wiring board (not shown).

Since the capacitive touch panel sensor 180a shown in FIGS. 11 and 12 has layers similar to those of the capacitive touch panel sensor 380 shown in FIG. 10, except for the first detection electrodes 24a and the second detection electrodes 28, the same constituent elements will be denoted by the same references, and descriptions thereof will be omitted.

The capacitive touch panel sensor 180a shown in FIGS. 11 and 12 corresponds to a capacitive touch panel sensor which has two substrates with electrodes attached thereto, each substrate with electrodes attached thereto having a substrate, and detection electrodes and lead-out wires disposed on a surface of the substrate, and is obtained by sticking the substrates to each other via an adhesive layer so that the substrate of one substrate with electrodes attached thereto and the electrodes of the other substrate with electrodes attached thereto face to each other.

As described above, the first detection electrodes 24a and the second detection electrodes 28a are electrodes extending in the X-axis direction and in the Y-axis direction, respectively, and are composed of a transparent metal oxide such as an indium tin oxide (ITO). In FIGS. 11 and 12, in order to utilize the transparent electrode ITO as a sensor, with respect to the height of the resistance of the indium tin oxide (ITO) itself, the total amount of the wiring resistance is reduced by gaining an electrode area, and the characteristics of the transparent electrode are utilized and the light transmittance is secured by reducing the thickness.

Other than the ITO, examples of the material which can be used in the aspect include a zinc oxide (ZnO), an indium zinc oxide (IZO), a gallium zinc oxide (GZO), and an aluminum zinc oxide (AZO).

The patterning of the electrode portion (first detection electrodes 24a and second detection electrodes 28a) can be selected according to the material of the electrode portion, and a photolithographic method, a resist mask screen printing-etching method, an ink jet method, a printing method, or the like may be used.

(Protective Substrate)

The protective substrate 20 which is disposed on the adhesive sheet acts to protect the capacitive touch panel sensor 18 to be described later from the outside environment, and its main surface constitutes a touch surface.

The protective substrate 20 is preferably a transparent substrate, and a plastic film, a plastic plate, a glass plate, or the like is used. The thickness of the substrate is preferably appropriately selected according to the uses.

As the raw material of the plastic film and the plastic plate, for example, polyesters such as polyethylene terephthalate (PET) and polyethylene naphthalate (PEN); polyolefins such as polyethylene (PE), polypropylene (PP), polystyrene, and EVA; vinyl-based resins; and other materials such as polycarbonate (PC), polyamide, polyimide, acrylic resins, triacetyl cellulose (TAC), and cycloolefin-based resins (COP) can be used.

A polarizing plate, a circularly polarizing plate, or the like may be used as the protective substrate 20.

(Display Device)

The display device 50 is a device having a display surface which displays an image, and members are disposed on the display surface side.

The type of the display device 50 is not particularly limited, and a known display device can be used. Examples thereof include a cathode-ray tube (CRT) display, a liquid crystal display (LCD), an organic light emitting diode (OLED) display, a vacuum fluorescent display (VFD), a plasma display panel (PDP), a surface-conduction electron-emitter display (SED), a field emission display (FED), and electronic paper (E-Paper).

The above-described adhesive sheet can be preferably used in the manufacturing of capacitive touch panels. For example, the adhesive sheet is used to provide an adhesive sheet to be disposed between a display device and the capacitive touch panel sensor, between the capacitive touch panel sensor and a protective substrate, or between a substrate in the capacitive touch panel sensor and a conductive film provided with detection electrodes disposed on the substrate.

Particularly, the adhesive sheet of the invention is preferably used to provide an adhesive layer adjacent to the detection electrodes in the capacitive touch panel. The adhesive sheet of the invention is preferably used in such an aspect since touch malfunction occurring by the influences of the fluctuation factors can be significantly reduced.

Examples of the case in which the adhesive sheet is adjacent to the detection electrodes include a case in which when the capacitive touch panel sensor has an aspect in which detection electrodes are disposed on front and rear surfaces of a substrate, the adhesive sheet is disposed to come into contact with the detection electrodes of both of the surfaces. In addition, as another case, a case in which the capacitive touch panel sensor has two conductive films, each of which is provided with a substrate and detection electrodes disposed on one surface of the substrate, and the adhesive sheet is disposed so as to come into contact with the detection electrodes when the two conductive films are stuck to each other is exemplified. Specific examples thereof include cases used as the aspects of the adhesive sheets 40 of FIGS. 9 and 10.

The interface of electronic equipment shifts to an era of more intuitive touch sensing from the graphical user interface, and the mobile use environment other than mobile phones has also been developed. The range of the application of mobile equipment having a capacitive touch panel installed therein has also been expanded from small-sized smartphones to medium-sized tablets, laptop computers, or the like, and there is a growing tendency of an increase in the size of a screen to be used.

Since the number of operating lines (number of detection electrodes) is increased with an increase in the size in a diagonal direction of the input region capable of detecting the contact of an object in the capacitive touch panel sensor, it is necessary to reduce a required scan time per line. In order to maintain a sensing environment appropriate for mobile use, an object is to reduce the parasitic capacitance and the temperature variation amount of the capacitive touch panel sensor. In a conventional adhesive layer, the temperature dependency of the specific dielectric constant is high, and there is a concern that as the size is increased, the sensing program cannot follow (malfunction occurs). In contrast, when using the adhesive layer in which the temperature dependency of the specific dielectric constant is low, an appropriate sensing environment is obtained as the size in the diagonal direction of the input region (sensing portion) capable of detecting the contact of an object in the capacitive touch panel sensor is greater than 5 inches, and when the size is more preferably 8 inches or greater, and even more preferably 10 inches or greater, a high effect can be exhibited in the suppression of malfunction. The input region having the above size has a rectangular shape.

In general, the size of the display screen of the display device is also increased with an increase in the input region of the capacitive touch panel sensor.

### EXAMPLES

Hereinafter, the invention will be described in more detail with examples, but is not limited thereto.

### Synthesis Example 1

### Acrylic Polymer Having O/C Ratio of 0.18

2-ethylhexyl acrylate (70 g), isobornyl acrylate (70 g), dodecyl acrylate (7.8 g), hydroxyethyl acrylate (7.8 g), and ethyl acetate (39 g) were mixed and stirred for 15 minutes at 90° C. under a nitrogen stream to remove oxygen in the system. Next, azobisisobutyronitrile (0.04 g) was added thereto, and the mixture was stirred for 3 hours at 90° C. Then, azobisisobutyronitrile (0.04 g) and ethyl acetate (140 g) were added thereto, and the mixture was stirred for 2 hours at 90° C. In addition, toluene (78 g) was added thereto, and thus an acrylic polymer solution A was obtained.

The mass ratio of 2-ethylhexyl acrylate (70 g), isobornyl acrylate (70 g), dodecyl acrylate (7.8 g), and hydroxyethyl acrylate (7.8 g) was 45:45:5:5.

### Synthesis Example 2

### Acrylic Polymer Having O/C Ratio of 0.20

2-ethylhexyl acrylate (160 g), hydroxyethyl acrylate (8.4 g), and ethyl acetate (42 g) were mixed and stirred for 15 minutes at 90° C. under a nitrogen stream to remove oxygen in the system. Next, azobisisobutyronitrile (0.05 g) was added thereto, and the mixture was stirred for 3 hours at 90° C. Then, azobisisobutyronitrile (0.05 g) and ethyl acetate (154 g) were added thereto, and the mixture was stirred for 2 hours at 90° C. In addition, toluene (84 g) was added thereto, and thus an acrylic polymer solution B was obtained.

The mass ratio of 2-ethylhexyl acrylate (160 g) and hydroxyethyl acrylate (8.4 g) was 95:5.

### Synthesis Example 3

### Acrylic Polymer Having O/C Ratio of 0.11

Isostearyl acrylate (148 g), hydroxyethyl acrylate (7.8 g), and ethyl acetate (39 g) were mixed and stirred for 15 minutes at 90° C. under a nitrogen stream to remove oxygen in the system. Next, azobisisobutyronitrile (0.04 g) was added thereto, and the mixture was stirred for 3 hours at 90° C. Then, azobisisobutyronitrile (0.04 g) and ethyl acetate (140 g) were added thereto, and the mixture was stirred for 2 hours at 90° C. In addition, toluene (78 g) was added thereto, and thus an acrylic polymer solution C was obtained.

The mass ratio of isostearyl acrylate (148 g) and hydroxyethyl acrylate (7.8 g) was 95:5.

### Synthesis Example 4

### Acrylic Polymer Having O/C Ratio of 0.19

2-ethylhexyl acrylate (95 g), N-vinylpyrrolidone (95 g), hydroxyethyl acrylate (10 g), and ethyl acetate (67 g) were mixed and stirred for 15 minutes at 90° C. under a nitrogen stream to remove oxygen in the system. Next, azobisisobutyronitrile (0.07 g) was added thereto, and the mixture was stirred for 3 hours at 90° C. Then, azobisisobutyronitrile (0.07 g) and ethyl acetate (143 g) were added thereto, and the mixture was stirred for 2 hours at 90° C. In addition, toluene (90 g) was added thereto, and thus an acrylic polymer solution D was obtained.

The mass ratio of 2-ethylhexyl acrylate (95 g), N-vinylpyrrolidone (95 g), and hydroxyethyl acrylate (10 g) was 47.5:47.5:5.

### Comparative Synthesis Example 1

### Acrylic Polymer Having O/C Ratio of 0.25

2-ethylhexyl acrylate (80 g), isobornyl acrylate (40 g), hydroxyethyl acrylate (40 g), and ethyl acetate (270 g) were mixed and stirred for 15 minutes at 90° C. under a nitrogen stream to remove oxygen in the system. Next, azobisisobutyronitrile (0.05 g) was added thereto, and the mixture was stirred for 3 hours at 90° C. Then, azobisisobutyronitrile (0.05 g) was added thereto, and the mixture was stirred for 2 hours at 90° C. to obtain an acrylic polymer solution E.

The mass ratio of 2-ethylhexyl acrylate (80 g), isobornyl acrylate (40 g), and hydroxyethyl acrylate (40 g) was 50:25:25.

### Example 1

The acrylic polymer solution A (10 g, solid content: 3.8 g), a hydrogenated terpene phenol resin (15 g, UH-115 manufactured by Yasuhara Chemical Co., Ltd., O/C ratio: 0.006), and Coronate L-55 (41 mg, solid content: 23 mg, isocyanate-based crosslinking agent manufactured by Nippon Polyurethane Industry Co., Ltd.) were mixed and stirred well. Next, the mixed liquid was applied to a release PET, and was dried by heating for 3 minutes at 120° C. Thereafter, the release PET was stuck to a composition, and was left for 72 hours under the condition of 40° C. to obtain an adhesive film with an adhesive sheet sandwiched between the release PETs. The adhesive sheet is a (meth)acrylic adhesive, and contains the acrylic polymer having an O/C ratio of 0.18, obtained in the above-described Synthesis Example 1, and the above-described hydrogenated terpene phenol resin as a hydrophobic additive.

Table 1 to be described later shows O/C ratios of adhesive sheets. The O/C ratio is the above-described ratio (number of moles of oxygen atoms/number of moles of carbon atoms). The calculation method is as described above.

### Examples 2 to 11 and Comparative Examples 1 to 7

Adhesive films were produced in the same manner as in Example 1, except that the type of the solution containing the (meth)acrylic adhesive, the type of the hydrophobic additive, and the amount of the hydrophobic additive added were changed as described in Table 1.

The following products were used as the respective hydrophobic additives.

Aromatic Modified Terpene 1 (TO85 manufactured by Yasuhara Chemical Co., Ltd., O/C ratio: 0)

Aromatic Modified Terpene 2 (YS Resin LP manufactured by Yasuhara Chemical Co., Ltd., O/C ratio: 0)

Rosin Resin (KE-100 manufactured by Arakawa Chemical Industries, Ltd., O/C ratio: 0.10)

Diisodecyl Phthalate (manufactured by Wako Pure Chemical Industries, Ltd., O/C ratio: 0.14)

Styrene-Butadiene Copolymer (manufactured by Sigma-Aldrich Co. LLC., O/C ratio: 0)

Polyisobutylene (manufactured by JX Nippon Oil & Energy Corporation, O/C ratio: 0)

### Various Evaluations

### Temperature Dependency Evaluation Test

One release PET of each of the adhesive films produced in Examples 1 to 11 and Comparative Examples 1 to 7 was peeled to stick the exposed adhesive sheet (thickness: 100 μm) to an aluminum (Al) substrate having a size of 20 mm (length) by 20 mm (width) and a thickness of 0.5 mm, and then the other release PET was peeled to stick the A1 substrate to the exposed adhesive sheet. Then, a pressurizing/defoaming treatment was performed for 60 minutes at 5 atmospheres at 40° C. to produce a sample for a temperature dependency evaluation test.

Regarding the thickness of the adhesive layer in each sample, a thickness of the temperature dependency evaluation test sample was measured at five places by a micrometer, and from an average value thereof, a total thickness of the two A1 substrates was subtracted to calculate the thickness of the adhesive layer.

Using the sample for a temperature dependency evaluation test produced as described above, impedance measurement at 1 MHz was performed using an impedance analyzer (Agilent Technologies, 4294A), and a specific dielectric constant of the adhesive sheet was measured.

Specifically, the temperature of the sample for a temperature dependency evaluation test was increased from −40° C. to 80° C. by 20° C. in stages to obtain a capacitance C by impedance measurement at 1 MHz using an impedance analyzer (Agilent Technologies, 4294A) at each temperature. The sample was left for 5 minutes at each temperature until the temperature of the sample was stabilized.

Then, using the obtained capacitance C, the specific dielectric constant at each temperature was calculated through the following Expression (X).

specific dielectric constant=(capacitance C×thickness T)/(area S×dielectric constant ∈₀ of vacuum) Expression (X):

The thickness T means a thickness of the adhesive sheet, the area S means an area (20 mm (length)×20 mm (width)) of the aluminum electrode, and the dielectric constant co of vacuum means a physical constant (8.854×10⁻¹² F/m).

Among the calculated specific dielectric constants, a minimum value and a maximum value were selected, and temperature dependency (%) (Δ∈%) was obtained through an expression [{(maximum value−minimum value)/minimum value}×100].

The temperature adjustment was performed in such a manner that a liquid nitrogen cooling stage was used in the case of low temperature and a hot plate was used in the case of high temperature.

[Malfunction Evaluation Method]

First, a method of manufacturing a touch panel to be used in the malfunction evaluation test will be described as follows.

(Preparation of Halogenated Silver Emulsion)

To the following liquid 1 kept at 38° C. at pH 4.5, the following liquid 2 and liquid 3 were simultaneously added for over 20 minutes under stirring in amounts of 90%, respectively, and thus nuclear particles of 0.16 μm were formed. Next, the following liquid 4 and liquid 5 were added for over 8 minutes, and the last 10% of the following liquid 2 and liquid 3 were added for over 2 minutes, respectively, to grow the particles up to 0.21 μm. 0.15 g of potassium iodide was added, the mixture was aged for 5 minutes, and the formation of the particles was completed.

| Liquid 1: | | |
|---|---|---|
| Water | 750 | ml |
| Gelatin | 9 | g |
| Sodium Chloride | 3 | g |
| 1,3-Dimethylimidazolidine-2-Thione | 20 | mg |
| Sodium Benzene Thiosulfonate | 10 | mg |
| Citric Acid | 0.7 | g |
| Liquid 2: | | |
| Water | 300 | ml |
| Silver Nitrate | 150 | g |
| Liquid 3: | | |
| Water | 300 | ml |
| Sodium Chloride | 38 | g |
| Potassium Bromide | 32 | g |
| Potassium Hexachloroiridate (III) | 8 | ml |
| (0.005% KCl, 20% aqueous solution) | | |
| Ammonium Hexachlorinated Rhodiumate | 10 | ml |
| (0.001% NaCl, 20% aqueous solution) | | |
| Liquid 4: | | |
| Water | 100 | ml |
| Silver Nitrate | 50 | g |
| Liquid 5: | | |
| Water | 100 | ml |
| Sodium Chloride | 13 | g |
| Potassium Bromide | 11 | g |
| Yellow Prussiate of Potash | 5 | mg |

Thereafter, the particles were rinsed in the usual manner through a flocculation method. Specifically, the temperature was reduced to 35° C., and the pH was reduced (pH 3.6±0.2) using a sulfuric acid until the halogenated silver was precipitated. Next, about 3 L of the supernatant was removed (first rinsing). 3 L of distilled water was added, and then a sulfuric acid was added until the halogenated silver was precipitated. 3 L of the supernatant was removed again (second rinsing). The same operation as the second rinsing was repeated once again (third rinsing), and the rinsing/desalination process was completed. The pH and the pAg of the emulsion after the rinsing and desalination were adjusted to 6.4 and 7.5, respectively, and 3.9 g of gelatin, 10 mg of sodium benzene thiosulfonate, 3 mg of sodium benzene thiosulfinate, 15 mg of sodium thiosulfate, and 10 mg of a chlorauric acid were added to perform chemical sensitization so as to obtain the optimum sensitivity at 55° C. 100 mg of 1,3,3a,7-tetraazaindene as a stabilizer and 100 mg of Proxel (trade name, manufactured by ICI Co., Ltd.) as a preservative were added. The finally obtained emulsion was a cubic silver iodochlorobromide particle emulsion containing 0.08 mole % of silver iodide and having a silver chloride-bromide ratio of 70 mole % of silver chloride and 30 mole % of silver bromide, an average particle size of 0.22 μm, and a coefficient of variation of 9%.

(Preparation of Photosensitive Layer Forming Composition)

1.2×10⁻⁴ mole/moleAg of 1,3,3a,7-tetraazaindene, 1.2×10⁻² mole/moleAg of hydroquinone, 3.0×10⁻² mole/moleAg of a citric acid, and 0.90 g/moleAg of 2,4-dichloro-6-hydroxy-1,3,5-triazine sodium salt were added to the emulsion, and the pH of the coating liquid was adjusted to 5.6 using a citric acid. Thus, a photosensitive layer forming composition was obtained.

(Photosensitive Layer Forming Process)

A polyethylene terephthalate (PET) film having a thickness of 100 μm was subjected to a corona discharge treatment, and then a gelatin layer as an undercoat layer having a thickness of 0.1 μm was provided on both surfaces of the PET film, and an antihalation layer having an optical density of about 1.0 and containing a dye to be decolorized with alkali of a developer was provided on the undercoat layer. The photosensitive layer forming composition was applied to the antihalation layer, and a gelatin layer having a thickness of 0.15 μm was provided thereon, whereby a PET film having a photosensitive layer formed on both surfaces was obtained. The obtained film is set as a film A. The formed photosensitive layer had a silver amount of 6.0 g/m² and a gelatin amount of 1.0 g/m².

(Exposure and Development Process)

Both surfaces of the film A were exposed using parallel light with a high pressure mercury lamp as a light source via a photomask in which detection electrodes (first detection electrodes and second detection electrodes) and lead-out wires (first lead-out wires and second lead-out wires) were arranged as shown in FIG. 6. After the exposure, development was performed with a developer, and a development treatment was further performed using a fixing liquid (trade name: N3X-R for CH16X manufactured by Fujifilm Corporation). By performing rinsing with pure water and drying, a capacitive touch panel sensor A having the detection electrodes composed of fine Ag wires and the lead-out wires provided on both surfaces was obtained.

In the obtained capacitive touch panel sensor A, the detection electrodes are composed of fine conductive wires intersecting in a mesh state. As described above, the first detection electrodes are electrodes extending in the X-direction, and the second detection electrodes are electrodes extending in the Y-direction. The first detection electrodes and the second detection electrodes are disposed on the film at a pitch of 4.5 mm to 5 mm, respectively.

Next, using each of the adhesive films produced in Examples 1 to 11 and Comparative Examples 1 to 7, a touch panel including a liquid crystal display, a lower adhesive layer, a capacitive touch panel sensor, an upper adhesive layer, and a glass substrate in this order was manufactured. As the capacitive touch panel sensor, the capacitive touch panel sensor A manufactured as described above was used.

In a method of manufacturing the touch panel, one release PET of the adhesive film was peeled, and the adhesive sheet was stuck to the capacitive touch panel sensor using a 2 kg weight roller to produce the upper adhesive layer. Furthermore, the other release PET was peeled, and on the upper adhesive layer, the glass substrate having the same size was stuck similarly using a 2 kg weight roller. Then, the resulting material was exposed to an environment of 40° C. and 5 atmospheres for 20 minutes in a high pressure thermostatic tank, and a defoaming treatment was performed.

Next, using the adhesive film used in the production of the upper adhesive layer, the lower adhesive layer was disposed in the same manner as in the production of the upper adhesive layer between the capacitive touch panel sensor of the structure in which the glass substrate, the upper adhesive layer, and the capacitive touch panel sensor were stuck in this order and the liquid crystal display to stick them to each other.

Then, the touch panel obtained as described above was exposed to an environment of 40° C. and 5 atmospheres for 20 minutes in a high pressure thermostatic tank, and a predetermined touch panel was manufactured.

As the lower adhesive layer and the upper adhesive layer in the touch panel, the adhesive sheets described in the examples and the comparative examples are used (see Table 1).

In the examples and the comparative examples, the length of a diagonal of a touch portion (sensing portion) in the capacitive touch panel sensor was 5 inches so as to match the size (length of diagonal) of a display screen of the liquid crystal display.

The temperature of the touch panel produced as described above was increased from −40° C. to 80° C. by 20° C. in stages, and a rate of occurrence of malfunction at the time of touch at each temperature was measured. That is, an arbitrary place was touched 100 times under environments of −40° C., −20° C., 0° C., 20° C., 40° C., 60° C., and 80° C., and the rate (%) of occurrence of malfunction of the touch panel [(number of unnormal reactions/100)×100] was measured from the number of cases in which an unnormal reaction occurred. When performing touch, the touch was performed so that the touch time was shorter than usual, that is, not longer than 0.1 seconds.

Among the measured rates of occurrence of malfunction at the temperatures, a maximum value was calculated and evaluated according to the following standards. A or B is preferred for practical use.

“A”: The maximum value is less than 5%.

“B”: The maximum value is 5% to less than 10%.

“C”: The maximum value is 10% or greater.

[Measurement of Loss Tangent]

An adhesive sheet having an average thickness of 500 μm, obtained by adjusting the thickness in each of the examples and the comparative examples, was punched out into a rectangular shape of 5 mm×22 mm and was held by measurement chucks. While applying shear strain at a frequency of 10 Hz using a viscoelasticity tester (device name “Rheogel-E4000” manufactured by UBM), viscoelasticity was measured in a shear mode at a rate of temperature increase of 5° C./min within a temperature region of −50° C. to 100° C., and a temperature at which the maximum value of loss tangent (tans) is shown was obtained. The average thickness was a value obtained by measuring thicknesses of ten arbitrary places in the adhesive sheet and by arithmetically averaging the measured values.

[Adhesive Strength Measurement]

The adhesive sheet obtained in each of the examples and the comparative examples was cut out into a size of 2.5 cm×5 cm, and a sample was produced in which one surface of the obtained adhesive sheet was stuck to a glass substrate and the other surface was stuck to a kapton film. Next, using an Autograph manufactured by Shimadzu Corporation, one end of the kapton film was gripped, and a 180-degree peeling test (tension rate: 300 cm/min) was performed. A test force average value of the adhesive sheet and the glass substrate was measured, and this value was set as an adhesive strength (N/mm) The evaluation was performed according to the following standards. A or B is preferred for practical use.

“A”: 0.5 N/mm or greater

“B”: 0.1 N/mm to less than 0.5 N/mm

“C”: less than 0.1 N/mm

[Appearance Evaluation]

The adhesive sheet obtained in each of the examples and the comparative examples was stuck to a glass substrate and visually observed under a fluorescent lamp. The evaluation was performed according to the following standards. A is preferred for practical use.

“A”: Transparent with no cloudiness.

“B”: Cloudiness is shown.

In Table 1, the O/C ratio means a ratio (molar amount of oxygen atoms/molar amount of carbon atoms). The O/C ratio of adhesive indicates an O/C ratio of the (meth)acrylic adhesive, the O/C ratio of additive indicates an O/C ratio of the hydrophobic additive, and the total O/C ratio indicates an O/C ratio of the adhesive sheet. The calculation methods are as described above.

In Table 1, in the column titled “Amount Added” of “Hydrophobic Additive”, the content (mass %) of the hydrophobic additive with respect to the total mass of the adhesive sheet is shown. The numerical values corresponding to Example 8 mean that 36 mass % of the aromatic modified terpene 1 and 24 mass % of the aromatic modified terpene 2 were used.

In Table 1, “Δ∈(%)” means the temperature dependency (%).

In Table 1, in the column titled “Rate of occurrence of malfunction (%)”, the evaluation result is shown on the left side, and the numerical value of the rate of occurrence of malfunction (%) is shown on the right side.

In Table 1, in the column titled “Adhesive Strength (N/mm)”, the evaluation result is shown on the left side, and the numerical value of the adhesive strength (N/mm) is shown on the right side.

In Table 1, in the column titled “Total Evaluation”, a case in which all of “Rate of occurrence of malfunction (%)”, “Adhesive Strength (N/mm)”, and “Appearance” were evaluated to be “A” was indicated by “A”, a case in which any one of “Rate of occurrence of malfunction (%)” and “Adhesive Strength (N/mm)” was “B” and “Appearance” was “A” was indicated by “B”, and a case in which any one of “Rate of occurrence of malfunction (%)” and “Adhesive Strength (N/mm)” was “C”, or “Appearance” was “B” was indicated by “C”.

“A” or “B” is preferred for practical use.

TABLE 1

| | | | | | | Adhesive | | | | | | |
|---|---|---|---|---|---|---|---|---|---|---|---|---|
| | | | | | | Sheet | | Various Evaluations | | | | |
| | (Meth)acrylic | | | | | | Maximum | | Rate of | | | |
| | Adhesive | | Hydrophobic Additive | | | | Value of | | Occurrence | | | |
| | | O/C | | Amount | O/C | Total | Loss | | of Mal- | Adhesive | | Total |
| | Solution | Ratio of | | Added | Ratio of | O/C | Tangent | Δε | function | Strength | Appear- | Evalu- |
| | Type | Adhesive | Type | (wt %) | Additive | ratio | (° C.) | (%) | (%) | (N/mm) | ance | ation |
| Example 1 | A | 0.18 | Hydrogenated | 80 | 0.01 | 0.04 | 55 | 4 | A:1 | B:0.2 | A | B |
| | | | Terpene Phenol | | | | | | | | | |
| Example 2 | A | 0.18 | Hydrogenated | 60 | 0.01 | 0.07 | 45 | 9 | A:2 | A:1.1 | A | A |
| | | | Terpene Phenol | | | | | | | | | |
| Example 3 | A | 0.18 | Hydrogenated | 40 | 0.01 | 0.1 | 34 | 14 | A:4 | A:0.8 | A | A |
| | | | Terpene Phenol | | | | | | | | | |
| Example 4 | A | 0.18 | Hydrogenated | 20 | 0.01 | 0.14 | 25 | 19 | B:8 | A:0.6 | A | B |
| | | | Terpene Phenol | | | | | | | | | |
| Example 5 | A | 0.18 | Aromatic | 60 | 0 | 0.06 | 40 | 8 | A:2 | A:1.1 | A | A |
| | | | Modified | | | | | | | | | |
| | | | Terpene 1 | | | | | | | | | |
| Example 6 | B | 0.2 | Hydrogenated | 65 | 0.01 | 0.07 | 5 | 10 | A:2 | B:0.2 | A | B |
| | | | Terpene Phenol | | | | | | | | | |
| Example 7 | A | 0.18 | Rosin Resin | 65 | 0.1 | 0.13 | 40 | 19 | B:7 | A:0.7 | A | B |
| Example 8 | A | 0.18 | Aromatic | 60 | 0 | 0.06 | 24 | 9 | A:2 | A:0.7 | A | A |
| | | | Modified Terpene | (36 + 24) | | | | | | | | |
| | | | 1 + 2 | | | | | | | | | |
| Example 9 | C | 0.11 | Aromatic | 60 | 0 | 0.04 | 30 | 4 | A:1 | A:0.6 | A | A |
| | | | Modified | | | | | | | | | |
| | | | Terpene 1 | | | | | | | | | |
| Example 10 | C | 0.11 | Styrene Butadiene | 30 | 0 | 0.08 | 12 | 10 | A:4 | B:0.2 | A | B |
| | | | Copolymer | | | | | | | | | |
| Example 11 | D | 0.19 | Polyisobutylene | 40 | 0 | 0.1 | 2 | 19 | B:8 | A:1.1 | A | B |
| Comparative | A | 0.18 | None | — | — | 0.18 | 10 | 25 | C:13 | A:0.5 | A | C |
| Example 1 | | | | | | | | | | | | |
| Comparative | A | 0.18 | Hydrogenated | 10 | 0.01 | 0.16 | 15 | 21 | C:10 | A:0.5 | A | C |
| Example 2 | | | Terpene Phenol | | | | | | | | | |
| Comparative | B | 0.2 | Hydrogenated | 20 | 0.01 | 0.15 | −30 | 19 | B:8 | C:0.05 | A | C |
| Example 3 | | | Terpene Phenol | | | | | | | | | |
| Comparative | E | 0.25 | Hydrogenated | 40 | 0.01 | 0.13 | 30 | 19 | B:7 | A:0.8 | B | C |
| Example 4 | | | Terpene Phenol | | | | | | | | | |
| Comparative | E | 0.25 | Hydrogenated | 20 | 0.01 | 0.19 | 23 | 29 | C:20 | A:0.5 | B | C |
| Example 5 | | | Terpene Phenol | | | | | | | | | |
| Comparative | A | 0.18 | Diisodecyl | 20 | 0.14 | 0.19 | −4 | 28 | C:18 | B:0.3 | B | C |
| Example 6 | | | Phthalate | | | | | | | | | |
| Comparative | E | 0.25 | Diisodecyl | 20 | 0.14 | 0.23 | −4 | 33 | C:23 | B:0.3 | B | C |
| Example 7 | | | Phthalate | | | | | | | | | |

As shown in Table 1, in the adhesive sheets of the invention, excellent adhesiveness and appearance characteristics were exhibited, and the occurrence of malfunction of a touch panel including the adhesive sheet was suppressed. Among these, in Examples 1 to 3, 5, 6, and 8 to 10 in which the above-described temperature dependency was 15% or less, the occurrence of malfunction was further suppressed. Among these, in Examples 2, 3, 5, 8, and 9 in which the content of the hydrophobic additive was 40 mass % to 60 mass %, more excellent adhesiveness was confirmed.

Comparative Examples 1, 2, and 5 to 7 in which the O/C ratio of the adhesive sheet was not within a predetermined range, Comparative Example 3 in which the loss tangent was not within a predetermined range, and Comparative Example 4 in which the O/C ratio of the (meth)acrylic adhesive was not within a predetermined range deteriorated in all of the adhesiveness, appearance characteristics, and the suppression of malfunction as compared to the examples.

### Explanation of References

12: adhesive sheet
18, 180, 180a, 280, 380: capacitive touch panel sensor
20: protective substrate
22: substrate
24, 24a: first detection electrode
26, 26a: first lead-out wire
28, 28a: second detection electrode
30: second lead-out wire
32: flexible printed wiring board
34: fine conductive wire
36: lattice
38: first substrate
40: adhesive sheet
42: second substrate
100: aluminum electrode
200, 300: laminate for touch panels
400, 500: capacitive touch panel

1. An adhesive sheet for touch panels comprising at least:
a (meth)acrylic adhesive; and
a hydrophobic additive,
wherein a ratio of the number of moles of oxygen atoms with respect to the number of moles of carbon atoms in the (meth)acrylic adhesive is 0.08 to 0.20,
the hydrophobic additive includes at least one selected from the group consisting of a hydrogenated terpene phenol resin and an aromatic modified terpene resin,
a ratio of the number of moles of oxygen atoms with respect to the number of moles of carbon atoms in the hydrophobic additive is 0 to 0.10,
the content of the hydrophobic additive is 40 mass % to 60 mass % with respect to the total mass of the adhesive sheet for touch panels,
a ratio of the number of moles of oxygen atoms with respect to the number of moles of carbon atoms contained in the adhesive sheet for touch panels is 0.03 to 0.15, and
a maximum value of loss tangent is shown within a range of −5° C. to 60° C.

2. The adhesive sheet for touch panels according to claim 1,
wherein the temperature dependency of a specific dielectric constant obtained from the following temperature dependency evaluation test is 20% or less,
temperature dependency evaluation test: the adhesive sheet for touch panels is sandwiched between aluminum electrodes, the temperature thereof is increased from −40° C. to 80° C. by 20° C., a specific dielectric constant of the adhesive sheet for touch panels is calculated by impedance measurement at 1 MHz at each temperature, a minimum value and a maximum value are selected from the specific dielectric constants calculated at the respective temperatures, and a value (%) obtained through an expression [{(maximum value−minimum value)/minimum value}×100] is set as temperature dependency.

3. A laminate for touch panels comprising:
the adhesive sheet for touch panels according to claim 1; and
a capacitive touch panel sensor.

4. A laminate for touch panels comprising:
the adhesive sheet for touch panels according to claim 2; and
a capacitive touch panel sensor.

5. The laminate for touch panels according to claim 3, further comprising:
a protective substrate,
wherein the capacitive touch panel sensor, the adhesive sheet for touch panels, and the protective substrate are provided in this order.

6. The laminate for touch panels according to claim 4, further comprising:
a protective substrate,
wherein the capacitive touch panel sensor, the adhesive sheet for touch panels, and the protective substrate are provided in this order.

7. A capacitive touch panel comprising, in this order, at least:
a display device;
the adhesive sheet for touch panels according to claim 1; and
a capacitive touch panel sensor.

8. A capacitive touch panel comprising, in this order, at least:
a display device;
the adhesive sheet for touch panels according to claim 2; and
a capacitive touch panel sensor.

9. The capacitive touch panel according to claim 7,
wherein the size in a diagonal direction of an input region capable of detecting the contact of an object in the capacitive touch panel sensor is 5 inches or greater.

10. The capacitive touch panel according to claim 8,
wherein the size in a diagonal direction of an input region capable of detecting the contact of an object in the capacitive touch panel sensor is 5 inches or greater.

11.-20. (canceled)
